(19) United States
(12) Patent Application Publication
(10) Pub. No.: US 2024/0152873 A1
(43) Pub. Date: May 9, 2024

(54) METHOD AND SYSTEM FOR PERSONALIZED PAYMENTS AND BENEFITS OPTIMIZATION

(71) Applicant: PWISE LTD, Modi'in (IL)

(72) Inventor: Avinoam YANAI, Modi'in (IL)

(21) Appl. No.: 18/282,066

(22) PCT Filed: Mar. 12, 2022
(86) PCT No.: PCT/IL22/50281

§ 371 Date: Sep. 14, 2023

(30) Foreign Application Priority Data
Mar. 14, 2021 (IL) 281477

(51) Int. Cl. G06Q 10/1057; G06Q 10/0635

(52) U.S. Cl. CPC G06Q 10/1057; G06Q 10/0635

(57) ABSTRACT

A method of calculating a personal value of a Benefit offer including considering specific customer probabilities to Grant and\or Redeem the specific Benefit offer, and applying weight factors to distinguish between probabilities values to consider customer risk profile and preference.

### FIELD OF THE INVENTION

The present invention relates to the field of payment optimization. More particularly, the invention relates to a payments and benefits optimization system, which relies on a personalized Benefit value calculation method and provides the customer with a real-time calculated recommendation on how to execute each payment.

### BACKGROUND OF THE INVENTION

Benefits are taking a major role in the commercial world. A variety of benefits are offered by merchants and payments institutes (like: Banks, Credit issuers) to customers in order to motivate him/her to make a certain action (like: purchase at their stores or use their payment tools). The variety of payments tools, the huge selection of different benefits, and the complexity of these benefits terms make it almost impossible for a customer to make a calculated real-time decision about which payment method is the most profitable for him to use at the purchase moment.

Furthermore, Benefits offers are divided into many benefit categories, which differ in their type, value, Grant conditions, Redeem conditions, etc. A significant portion of today's marketplace benefits depends on future customer actions or/and the customer's ability to fulfill some conditions in the future. As a result, a benefit value may not necessarily reflect the real benefit value for a specific customer. The same Benefit can have a different value for different customers, depending on their future actions or ability to fulfill some conditions in the future. Furthermore, a customer may prefer a specific benefit offered for reasons which are not directly related to its value. Therefore, a method to reflect a personalized value for benefit offers is critical to the ability to compare among different Benefit offers a customer needs to choose among them.

Furthermore, the payments actions duration is very short. Therefore, payment recommendations need to occur in short real-time, requiring quick real-time response with not much room for complex analysis.

It is, therefore, an object of the present invention to establish a methodology to calculate a personalized value (Customer Calculated Value—CCV) for all types of benefits offers, allowing to compare their value for a specific customer, establish optimization processes based on this methodology, provide a system to execute optimization processes and deliver to customers real-time recommendations allowing each customer to optimize and maximize his saving.

Other objects and advantages of the invention will become apparent as the description proceeds.

### SUMMARY OF THE INVENTION

A method to calculate a personalized value for each Benefit offer called, Calculated Customer Value—CCV is described. The method comprising: Defining Benefit offer Calculated Customer Value index—CCV(B), Incorporating Weight factors into CCV(B) index definition based on Weight rules, Defining CCV(B) index Sum rule; Defining Customer Action Domain—CAD and Benefit Options Domain—BOD, Defining Benefit event and the Benefit Option Range—BOR; Classifying Benefit events into categories based on CAD and BOD characteristics, Defining: Free Benefit, No benefit, Single value event, Single value group event, Multiple value event, Repeated-value Group event, Single-action event, Group event, and Time event. Defining Benefit event Calculated Customer Value index—CCV(E), Applying CCV(E) definition on Benefit event categories; Defining Equal Benefit option, Defining Limited Repeated value group event, Translating Customer Personalize conditions to Limited Repeated value group event; Defining Preferred Benefit Event (PBE) where Benefit events tradeoffs exist; Defining relative CCV(Bt)T index value for different time dependencies Benefit options and calculating CCV(Bt)T index value using either: Pure relative approach, Cumulative approach, Enhanced Value approach or a combination of them.

In another aspect, analytical computing processes using Calculated Customer Value—CCV methodology for Payments and Benefits optimization are described, comprising: Offline Profiling process which defines a T time period and established relevant Customer Actions Domain—CAD(T) and Benefit options Domain—BOD(T) using historical data, Mapping all Benefit events alternatives for CAD(T); Personalization routine option capturing Customer personal targets and their translations into Personalized customer conditions, Defining weight rules, adjusting Benefit event alternatives scheme; Adjusting all benefit options to T, calculating for each benefit option CCV parameters (BV, BC, BG, BR). Calculating each benefit option Weight factors (Vw, Cw, Gw, Rw) by Direct Weight rules translation, Empiric weight factors value calculation, or combined rules and empiric calculation approach. Calculating CCV(E) index value for all CAD(T) Benefit events alternatives, Defining T Preferred Benefit event—PBE(T), Characterizing PBE(T) and defining “T Customer profile”, “Vf(T) Profiled matrix” and “Cf(T) profiled matrix”. Executing real-time optimization process for a defined T time period using factor approach based on “Vf(T) Profiled matrix” and “Cf(T) profiled matrix”, a profile approach based “T Customer profile” translate to “T action plan” or a combined Factors and Profile approach. Monitoring optimization process performances along with T, identifying deviations, and applying correction as needed.

In another aspect, computer-implemented systems for Payments and Benefits optimization is described, comprising: System building blocks a Database, Customer Profiling engine, Benefit optimization engine, and an Application; Capturing Benefit options and Customer data into the Database general domain by the system administration, by benefits providers system through a network connection, by the customer through the application, or from web\ mobile applications through Application Programming Interfaces (API's) with the system application. Executing customer profiling process by the Customer profile engine and storing: “T customer profile”, “Typical Vf(T) Profiled matrix”, and “Typical Cf(T) profiled matrix” at the Customer profiling database. Benefit Optimization engine receiving customer action data from the customer or the Asset provider systems through the application or network connection, Executing Benefit optimization process, calculating Benefit event recommendation and communicating it to the customer or the Asset provider through the application or a joint network, Executing payment by the customer, Payment networks, or web\mobile Payment application which are connected to the application through Application Programming Interfaces (API's) with the system application or by Asset providers systems. Capturing customer events data into the Current T Database general domain by the customer through the application or automatically by the assets provider systems. Monitoring Current T performances, monitoring “T action plan” execution, identifying deviations, performing corrections to “T customer profile”, “Typical Vf(T) Profiled matrix” and “Typical Cf(T) profiled matrix” as needed, updating Benefit Optimization engine.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1a shows a weight factor Reset rule graph, which was defined to reset the CCV(B) value in case BG or BR is below 0.3, according to an embodiment of the invention;

FIG. 1b demonstrates Probability impact enhancements rules, according to an embodiment of the invention;

FIG. 1c demonstrates a Dynamic rule, according to an embodiment of the invention;

FIG. 1d demonstrates a Differentiation rule, according to an embodiment of the invention;

FIG. 2 demonstrates a terminology defined in order to apply CCV(B) on different Benefit options categories at the day-to-day marketplace, according to an embodiment of the invention;

FIG. 3a illustrates a Single value event, according to an embodiment of the invention;

FIG. 3b illustrates a Single value Group event, according to an embodiment of the invention;

FIG. 3c illustrates a Multiple value event, according to an embodiment of the invention;

FIG. 3d illustrates a Repeated-value Group event, according to an embodiment of the invention;

FIG. 3e illustrates a Single-action event, according to an embodiment of the invention;

FIG. 3f illustrates a Group event, according to an embodiment of the invention;

FIG. 4 shows the CCV(G) calculation flow, according to an embodiment of the invention;

FIG. 5A demonstrates an example of CCV(G) Group event calculation, according to an embodiment of the invention;

FIG. 5B demonstrates the Benefit event mapping process of CCV(G) Group event calculation example, according to an embodiment of the invention;

FIG. 5C shows an adjustment process of FIG. 5B Benefit events, according to an embodiment of the invention;

FIG. 5D demonstrates CCV parameters and Weight factor for FIG. 5C Benefit events, according to an embodiment of the invention;

FIG. 5E demonstrates (G) Benefit events alternatives scheme as a result of the adjustment process by applying Equal benefit options on the Customer event scheme shown in FIG. 5c, according to an embodiment of the invention;

FIG. 5F shows the CCV parameters and Weight factor for FIG. 5E Benefit events, according to an embodiment of the invention;

FIG. 5G shows the CCV(E) index values for each Benefit event on both benefit events scenarios (FIG. 5C and FIG. 5E), according to an embodiment of the invention;

FIG. 6 demonstrates three optional algorithms for calculating VwtT in order to enhance (Bt) value along a year, where each of the algorithms represents a different enhancement magnitude, according to an embodiment of the invention;

FIG. 7 shows CCV(T) calculation flow, which is similar to the CCV(G) calculation flow, according to an embodiment of the invention;

FIG. 8 shows the Customer profiling process flow, according to an embodiment of the invention;

FIG. 9 shows the calculation of Typical Benefit options T Value factor matrix, Typical Benefit options T Cost factor matrix and Typical T Customer profile are calculated, by applying statistical analysis methods, according to an embodiment of the invention;

FIG. 10 shows Factors that approach Customer optimization flow, according to an embodiment of the invention;

FIG. 11 shows a scheme of the Profile approach flow, according to an embodiment of the invention;

FIG. 12 shows a scheme of Combined Factors and Profile approach flow, according to an embodiment of the invention;

FIG. 13 shows a general scheme of the CCV Benefits optimization system, according to an embodiment of the invention;

FIG. 14 shows several implementations of the CCV benefits optimization system General domain setup, according to some embodiments of the invention.

FIG. 15 shows several implementations of the CCV benefits optimization system Customer profiling process, according to some embodiments of the invention.

FIG. 16 shows several implementations of the CCV benefits optimization system Benefit optimization process, according to some embodiments of the invention.

FIG. 17 shows several implementations of the CCV benefits optimization system Payment process, according to some embodiments of the invention.

FIG. 18 show several implementations of the CCV benefits optimization system Current T monitoring process, according to some embodiments of the invention.

### DETAILED DESCRIPTION OF THE INVENTION

Throughout this description, the term “Benefit option” indicates any Benefit offer a customer can get from any commercial or financial organ. This may include non-limitative Benefit offers like: Discounts, Coupons, Loyalty credit points, air miles, Improved Credit terms, etc. “Benefit option” has a value and sometimes direct or associated cost. Benefit option Grant refers to any occasion a customer becomes eligible to the “Benefit option” value. “Benefit option Redeem” refers to any occasion a customer exercises the Benefit option and gets its value

Throughout this description, the term “Payment system/network/tool” indicates an essential part of payment systems such as debit/credit cards, value Coupons, Web and Mobile Payment applications, etc. This term does not imply any particular type of payment system, and the invention is applicable to all suitable types of cards, credit transfers, direct debits, payment applications, and e-money (with which end users of payment systems transfer funds between accounts at banks or other financial institutions).

The present invention proposes a system and method for payments and benefits optimization, which provides the customer with a real-time recommendation for each purchase and, as a result, allows the customer to maximize benefits and save money.

The functions described herein may be performed by executable code and instructions or program modules stored in a computer-readable medium and running on one or more processor-based systems such as a server or a cloud computing system and an application that runs on a mobile device and is configured to communicate with the server via a communication network (e.g., via the Internet). Embodiments of the invention may be implemented as a computer process, e.g., a computer system that encodes a computer program of instructions for executing the computer process.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, cloud computers, and the like. The invention may also be practiced in distributed computing environments where tasks are performed by remote processing devices that are linked through a communications network. In a distributed computing environment, program modules may be located in both local and remote memory storage devices.

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

### Personalize Benefits Value Calculation

Embodiments of the present invention refer to the CCV methodology that seeks to create a personalized index value, which represents for each Benefit offer a relative index value that reflects this benefit offer value for a specific customer. The CCV methodology is applicable to any benefit category in today's marketplace. By applying the same personalization method on any benefit category, the CCV methodology creates a strong comparison tool between different benefits offers options a customer may have for a given action. Therefore, CCV methodology refers to any Benefit offer as a Benefit option that needs to be compared to alternative Benefit options for each customer action. CCV methodology benefit options comparison capabilities established the fundamentals for Benefits optimization systems.

According to an embodiment of the invention, the CCV methodology defines for any benefit option, an index value called CCV(B). In this embodiment, the CVV(B) index value incorporates the benefit option value, benefit option cost, and the probabilities that a customer will be able to grand or/and redeem this benefit option. CCV(B) index value is a particular value of a specific benefit option for a specific customer. A specific benefit option may have different CCV(B) values for each different customer.

The following Equation defines the CCV(B) index of a Benefit option (B):

CCV(B)=BV*BG*BR−BC Equation (1)
While:
BV: Benefit option Value
BC: Benefit option Cost
BG: Benefit option Grant Probability, (0≤BG≤1)
BR: Benefit option Redeem Probability, (0≤BR≤1)

As shown in Equation (1), CCV(B) index value is calculated by using four parameters: Benefit option Value (BV), Benefit option Cost (BC), Benefit option Redeem probability (BR), and Benefit option Grant probability (BG).

Benefit option Value (BV) is the benefit option of market value. BV can be seen as the customer saving when he redeems the benefit option. Calculating BV can sometimes be straightforward. For example: the BV of 20$ coupon Benefit option is 20$. Sometimes calculating BV requires minimal calculation, for example, 10% cashback for a specific purchase at store #1 benefit option. There is a need to know the total purchase cost and calculate BV as 10% of this amount. Sometimes calculating BV is complicated and requires some data analysis. For example, a benefit option: 10 Air-miles award points. In order to calculate BV, there is a need to know the cost of a flight ticket and the amount of Air-miles points needed to grant the ticket. If 100 Air-miles award points can be redeemed for a 150$ value flight ticket, 10 Air-miles award points BV will be 15$.

In some cases, BV depends on the way a customer intends to redeem a benefit option. For example, the Air-miles conversion rate into a flight ticket often depends on the flight timing and destination. Knowing the exact Air-miles award point the customer is willing to redeem will allow calculating a much more accurate BV. In such a case BV will be defined as a personalized BV.

Benefit option Cost (BC) is the associate cost with customer eligibility for a benefit option. Some benefit options have no associated costs. Sometimes several benefit options can be associated with the same benefit cost. For example, a merchant loyalty program membership monthly fee has an associated cost for all the benefit options a customer will grant or redeem in a month due to being a loyalty plan member. Sometimes costs are not connected directly to a benefits option eligibility but rather to a service the customer may get. For example, a credit card monthly fee while a customer who holds this credit card is eligible for some benefit options. In such a case, there is a need to evaluate if & what portion of the service fee is related to the benefit options.

Benefit option Grant probability (BG) is a statistical parameter that defines the probability that a specific customer will grant and become eligible for a specific benefit option. It's a common practice to define a condition that the customer needs to fill in order to grant a specific Benefit option. The aim of these grant conditions is to drive the customer to make a desirable action. Benefit grant conditions are mostly divided into two categories Volume conditions and Time conditions. A volume condition requires that the customer will make a certain amount of action (Such as achieving some spending level) to grant a Benefit option. A time condition requires that the customer will make certain actions during a defined time period in order to grant a Benefit option (Such: Getting coupons if a customer's feedback will be sent 30 days after getting a service). In many cases, both conditions, volume and time, co-exist. For example: Getting a 20$ coupon at store #1 if monthly spending at store #1 will exceed 200$. A Volume condition of 200$ spending at store #1 is combined with the Time condition that this spending needs to occur by the end of the month. In the case of volume condition, the BG value will be calculated as the probability that the customer will make the required amount of actions. In case of time conditions, the BG value will be calculated as the probability that the customer will make the required action at the defined time period. In the case of combined volume and time conditions, the BG value will be calculated as the probability that the customer will make the required amount of actions at the defined time period.

Benefit Redeem probability (BR) is a statistical parameter that defines the probability that a specific customer will redeem a Benefit option while he will grant it. The fact customer is granted a Benefit option doesn't necessarily mean he will redeem it and get its value. A real-time benefit option defines a benefit option that is redeemed at the same time it's granted. Real-time benefit option BR is 1 as the Benefit is redeemed at the same time the Benefit is granted, for example, discounts at current purchase, real-time cash backs, etc. Future benefit option defines as a benefit option that can be redeemed, not at the same time it's granted. Calculating the BR of a future benefit option may require determining on what occasions the future benefit option can be redeemed and the probability that these occasions will occur. For example, a 20$ discount on the next purchase at store #1 benefit option. The customer grants the 20$ discount Benefit option based on his current action (BG=1). However, the customer will be able to redeem the Benefit only if he makes an additional purchase at store #1. In this case, the BR value is calculated by a statistical analysis, which determines the probability that this specific customer will make an additional purchase at store #1. A conditional benefit option defines a benefit option that can be redeemed if certain conditions are fulfilled. Calculating a conditional benefit option BR may require determining the occasions the future benefit option can be redeemed, and if at these occasions redeemed conditions will be fulfilled. Therefore, calculations of conditional benefit option BR include two elements. Redeem occasions existence probability and the probability of redeeming conditions fulfillment on these occasions. Similar to grant conditions of a benefit option, redeem conditions of a benefit option are mostly: Volume conditions, Time conditions, or a combination of both Volume and Time conditions. For example, a benefit option of a 20$ discount for purchase above 200$ at store #1 in the next 30 days. The customer may grant the 20$ discount benefit option based on his current action. However, the customer will be able to redeem the Benefit only if he purchases above 200$ (Volume condition) at store #1 in the next 30 days (Time condition). In this case, the BR value is calculated as the probability that this specific customer will make a purchase at store #1 in the next 30 days (Time condition) and that this purchase will be above 200$ (Volume condition)

### CCV(B) Weight Factors

According to an embodiment of the invention, CCV(B) definition, as reflected in Equation (1), gives the benefit option value, benefit option grant & redeem probabilities the same impact on the benefit option CCV(B) index value. As a result, a high BV Benefit option with a low grant or redeem probability can have a Higher CCV(B) than a benefit option with a lower BV, but a much higher grant or redeem probability. However, a specific customer can prefer a lower BV value Benefit option but with a higher grant or redeem probability rather than a High BV Benefit option with a low grant or redeem probability. Such considerations need to be incorporated into the CCV(B) definition and may vary among different customers.

CCV methodology incorporates such considerations into CCV(B) index value by defining CCV parameters weight factors (Vw, Gw, Rw, Cw) for each of the CCV(B) equation parameters (BV, BG, BR, BC correspondingly). By multiplying each CCV(B) equation parameter with one or more weight factors, the CCV(B) equation linearity is revoked. Each of the CVV equation parameters can get a different relative weight. Incorporating weight factors into the CCV(B) equation (Equation 1), CCV(B) index value is defined as follows:

CCV(B)=(BV*Vw)*(BG*Gw)*(BR*Rw)−(BC*Cw) Equation (2)

While:
Vw—weight factor of Benefit option Value.
Rw—weight factor of Benefit option Redeem probability
Gw—weight factor of Benefit option Grant probability
Cw—weight factor of Benefit option Cost.

(Note: Equation (1) is a particular case of Equation (2), reflects a neutral customer that defines all the weight factors equal to 1).

There are many ways to define CCV(B) Weight factors. The logic theme behind the Weight factor values definition is called the Weight rule. Weight rule can be defined by the customer to reflect his personal preferences and risk profile. Weight rule can be defined by optimization computing systems based on various data analysis and statistic methods.

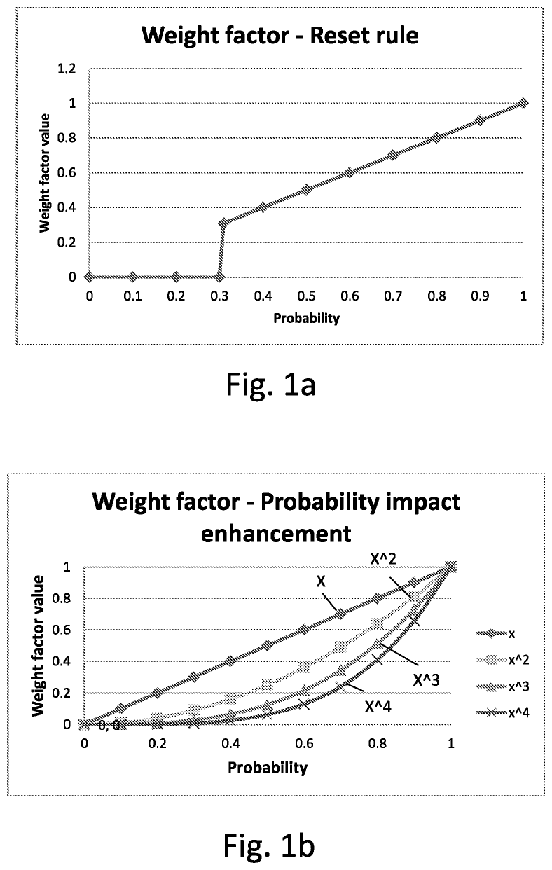

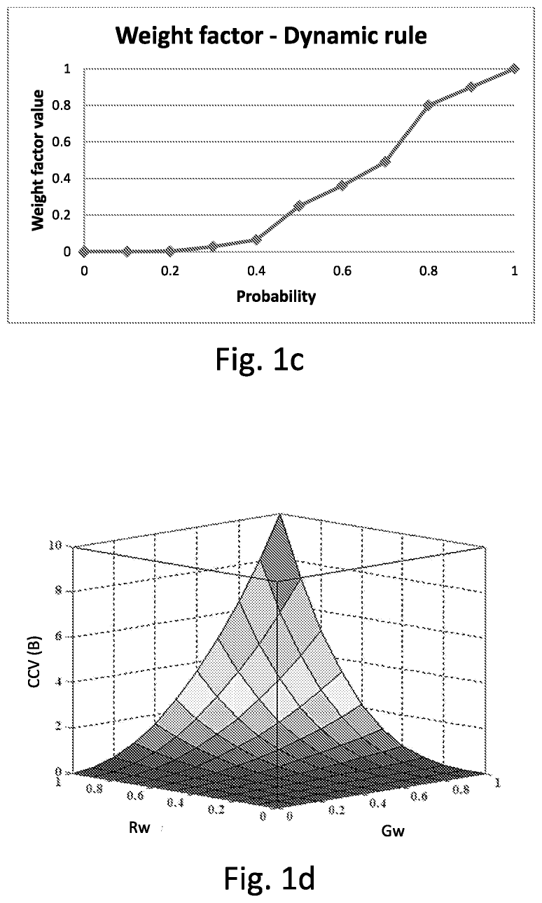

The above will be better understood through the following illustrative and non-limitative examples of Weight rules categories:
Benefit option Preferences rule: This rule logic theme is to prefer a specific Benefit option type over other Benefit option types. The weight rule defines preferred Benefit options with a Higher Vw factor value than other Benefit options types Vw factor value. The difference magnitude between the different Benefit options Vm's factors values determines CCV(B) index value bias magnitude toward preferred Benefit options.
Reset rule: This rule logic theme is to avoid low probability Grant or Redeem Benefits options. Weight rule defines nullifying the CCV(B) index value below a certain probability level. Below this probability level Rw=O and/or Gw=O, and as a result, CCV(B)=0. FIG. 1(a) demonstrates a weight factor Reset rule graph that was defined to reset the CCV(B) value in case BG or BR is below 0.3.
Probability impact enhancement: Grant and Redeem probabilities have a linear effect on the CCV(B) index value at equation (2). This rule logic theme is to increase BG and BR impact on the CCV(B) index value in order to lower CCV(B) index value more sharply as BG and BR probabilities get lower. Such rules can be applying square power, cube power, etc., on the Weight factors. FIG. 1(b) demonstrates some Probability impact enhancement rules.
Dynamic rule: Weight rules may combine several rules by applying different rules at different Gw and Rw values ranges. The weight rule is defined for each probability range differently. FIG. 1(c) demonstrates a dynamic rule.
Differentiation rule: The rule logic theme is to distinguish between the impact of the different CCV parameters on the CCV(B) index value. For example, in a case a customer is willing to Grant a low probability Benefit option but to have more certainty that he will be able to redeem this benefit option. The differentiation weight rule is defined to reflect higher Gw than Rw for the same probability. The difference magnitude between Gw and Rw determines the bias toward Gw. FIG. 1(d) demonstrates CCV(B) value of a Benefit option with BV=10, BC=0, Vw=1, while a Differentiation weighs rule by using different Probability impact enhancement rules is applied on Gw(square power) and Rw (cube power).

Equation (2) can be modified by merging a Vw, Gw and Rw weight factors into a single weight factor. This factor is defined as the Benefit option weight value (Bw). Bw is calculated as:

Bw=Vw*Gw*Rw Equation (3)

Introducing Equations (3) into Equation (2)

CCV(B)=(BV*BG*BR)*Bw−BC*Cw Equation (4)

Equation (4) can be modified by defining a single factor for the Benefit option value. This factor is defined as the Benefit option value factor (Vf). Vf is calculated as:

Vf=BG*BR*Bw Equation (5)

For consistency reasons, Cw defines the Benefit option cost factor (Cf). By introducing Equations (5) into Equation (4), the following Equation is received:

CCV(B)=BV*Vf−BC*Cf Equation (6)

The use of Equations (4) or Equation (6) instead of Equation (2) can simplify some optimization processes as will be described going forward.

### CCV(B) SUM Rule

CCV(B) SUM rule defines that the cumulative CCV index value of n independent Benefit options equals the sum of all their CCV(B) index values. The following Equation defines the CCV Sum rule for n independent Benefit options:

$$CCV ( B 1 + B 2 + … . + Bn ) = CCV ( {B}_{1} ) + CCV ( {B}_{2} ) + … + CCV ( {B}_{n} ) = {\sum }_{n = 1}^{n} C C V ( {B}_{n} ) = {\sum }_{n = 1}^{n} ( B {V}_{n} * B {G}_{n} * B {R}_{n} ) * B {w}_{n} - {\sum }_{n = 1}^{n} B {C}_{n} * C {w}_{n} = {\sum }_{n = 1}^{n} B {V}_{n} * V {f}_{n} - {\sum }_{n = 1}^{n} B {V}_{n} * C {f}_{n} \qquad Equation ( 7 )$$

### CCV(B) Applications on Benefit Options Categories

### Terminology Definitions

According to an embodiment of the invention, in order to apply CCV(B) on different Benefit options categories at the day-to-day marketplace, the following terminology (lent from Group theory) is defined:
Customer action is any activity a specific customer makes, leading him to grant and/or redeem Benefit options. For example: Making a purchase at a particular store, paying an electricity bill, asking for a credit line, buying flight tickets, etc.
Customer actions domain contains a single or group of customer actions. A logic principle defines which Customer actions include in a Customer actions domain. Customer actions domain is signed as CAD, Customer actions in CAD are called “CAD elements”, Nc is defined as the number of CAD elements.
Benefit options codomain contains a single or group of Benefit options. A logic principle defines which Benefit options include in a Benefit options codomain. Benefit options codomain is signed as BOD, benefit options in the domain are called “BOD elements”, Nb is defined as the number of BOD elements.
Benefit event is defined as a connection between CAD elements and BOD elements. A benefit event can be seen as a “function” that tie a single/group of CAD element (Customer actions) to single\group of BOD elements (Benefit options). The benefit event is how a customer is executing CAD elements to grant and/or redeem BOD elements.
Benefit options range is defined as the BOD elements which are contacted to at least one CAD element by a Benefit event. The benefit options range is signed as BOR. Benefit options in the BOR are called “BOR elements”.

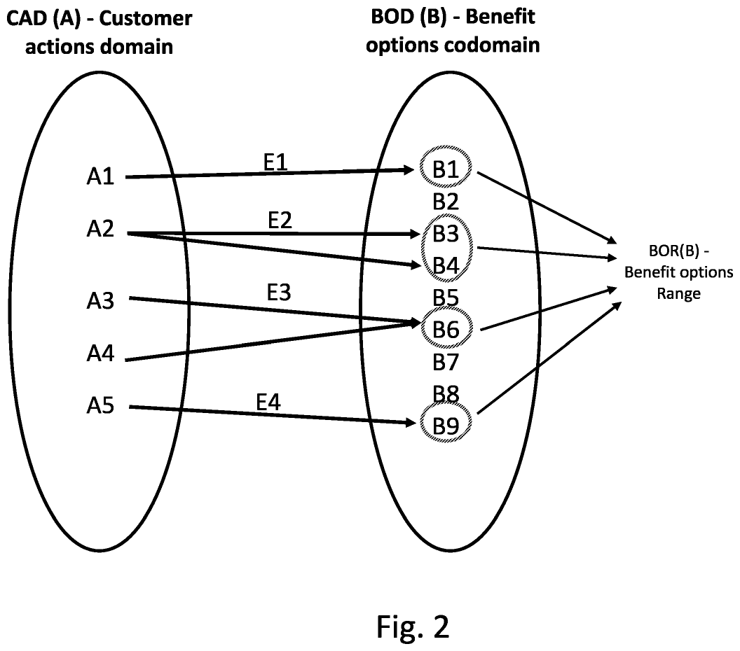

FIG. 2 demonstrates this terminology: CAD(A) is defined by the logic principle of “Customer actions which Customer A made at a specific day”. As customer A made five actions on this specific day, CAD(A) contains five elements (Customer actions A1, A2, A3, A4 and A5), Nc=5. According to an embodiment of the invention, BOD(B) is defined as all the Benefit options “Customer A” may Grant and\or Redeem while making CAD(A) elements (Customer actions). Nine Benefit options were found to have the possibility to be Grand and\or Redeem while Customer A makes CAD(A) elements (B1, B2, B3, B4, B5, B6, B7, B8 and B9). BOD(B) contains nine elements, Nb=9. As can be seen, four Benefit events E1, E2, E3 and E4 connect CAD(A) elements with BOD(B) elements. The first Benefit event (E1) is a way that while making Customer action number 1 (A1), the customer will grant and/or redeem Benefit option 1 (B1). For example: A1 is customer A purchase at store #1, B1 is a 5$ coupon for store #1 loyalty club members, E1 is customer A purchase at a store using his store #1 loyalty club membership card. E2 is a way that while making A2, the customer will grant and/or redeem two Benefit options B3 & B4. E3 is a way that while making both A3 & A4, the customer will grant and/or redeem Benefit option B6. E4 is a way that while making A5 the customer's grant and/or redeem Benefit option 9.

In the Benefit event scenario shown in FIG. 2, several BOD(B) elements are not connected by a Benefit event to any of the CAD(A) elements. In this scenario, BOR(B) includes Benefit options B1, B3, B4, B6, B9. As BOD(B) was defined as all the Benefit options Customer A can Grand and\or Redeem while making CAD(A) elements, another (at least 1) Benefit events scenario exists. BOR(B) is changed based on the existing Benefit events at each scenario. BOR elements reflect which Benefit options Customer A will Grant and\or Redeem while making CAD(A) elements at each Benefit events scenario.

### Benefit Events Categories

According to an embodiment of the invention, CAD & BOD characteristics are used at CVV methodology to distinguish between different Benefit events categories. The relationships between CAD & BOD elements, as defined by their logic principles, determine each Benefit events category. CCV(E) index values are calculated based on each Benefit events category characteristic, enabling CCV methodology to transform marketplace Benefit options into CCV methodology terms.

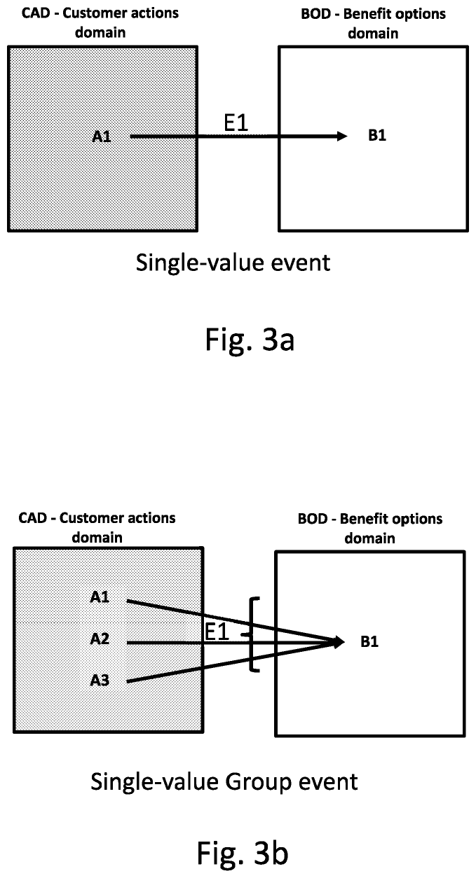

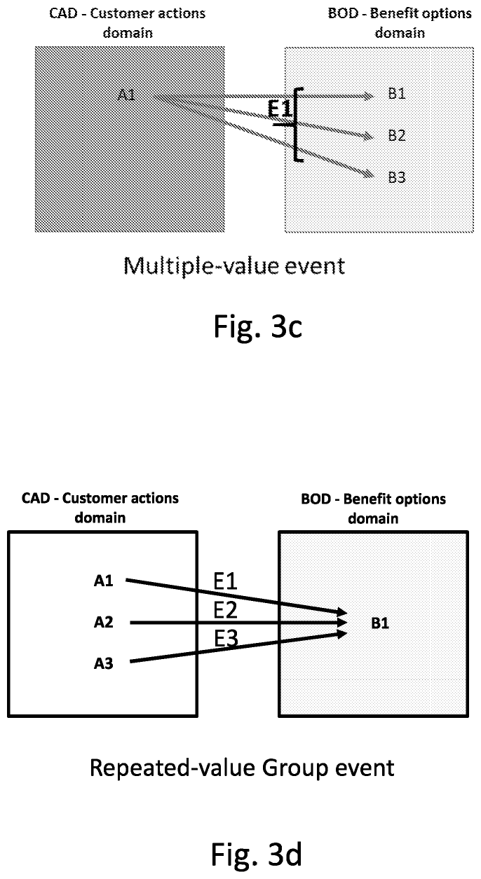

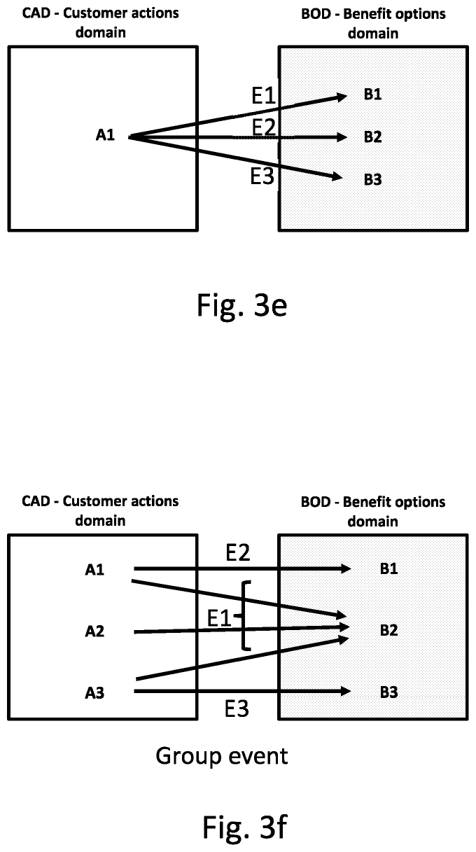

The above will be better understood through the following illustrative and non-limitative categories:
Category 1: Free Benefit is defined as a case where no Customer action is needed to grant and\or to redeem a Benefit option. In this case, CAD is an empty group (ϕ, Nc =0) while Nb>0. As no Customer action is needed to grant and/or redeem BOD elements, Benefit events don't exist.
Category 2: No benefit is defined as a case where a Customer action can't lead to grant and\or to redeem any Benefit option. In this case, BOD is an empty group (ϕ, Nb =0) while Nc>0. As no Benefit option is granted and\or redeemed by the CAD elements, Benefit events don't exist.
Category 3: Single-value event is defined as cases where a single Customer action has a single Benefit option the customer can grant and\or redeem. In this case, CAD contains one element (Nc=1), BOD contains one element (Nb=1), only one Benefit event exists (a single value event is illustrated in FIG. 3a. A1 customer action is the only CAD element, and B1 is the only Benefit option the customer can grant and/or redeem for A1. Therefore, B1 is the only BOD element. Only one Benefit event E1 exists in such a case).
Category 4: Single value Group event is defined as a case where several Customer actions are needed to grant or redeem a single Benefit option. In this case, the CAD contains several elements (Nc>1), BOD contains one element (Nb=1), only one Benefit event exists. (Single value Group event is illustrated in FIG. 3b).
Category 5: Multiple value event is defined as a case where a Single Customer action or

Several Customer actions can grant and/or redeem several Benefit options in parallel. In this case, the CAD contains one or several elements (Nc=1 or Nc>1)), BOD contains several elements (Nb>1), only one Benefit event exists. (Multiple value event is illustrated in FIG. 3c)
Category 6: Repeated-value Group event is defined as a case where Several Customer actions can grant and/or redeem the same Benefit option independently from each other. In this case, the CAD contains several elements (Nc>1), BOD contains one element (Nb=1), Nc Benefit event exists (Repeated-value Group event is illustrated FIG. 3d)
Category 7: Single-action event is defined as a case where single Customer action can grant and/or redeem several Benefit options while these Benefit options can't co-exist. Therefore the customer needs to choose which of the Benefits options to grant and\or redeem for this customer action. Benefit event alternative is defined as a single or combination of several Benefit events that can co-exist for s defined CAD. At a Single-action event, CAD contains one element (Nc=1), BOD contains several elements (Nb>1), Several Benefit event alternatives exist, BOR is defined for each Benefit event alternative based on the BOD elements which are related to each Benefit event alternative. (Single action event is illustrated in FIG. 3e. For a single Customer action A1, there are three optional Benefit options B1, B2, B3. Customers should choose among these benefit events; therefore, three Benefit events alternatives exist. E1 while pursuing B1, E2 while pursuing B2, E3 while pursuing B3. At E1, BOR contains only B1; at E2, BOR contains only B2; at E3, BOR contains only B3.
Category 8: Group event is defined as a case where several Customer actions can grant and/or redeem specific Benefit options; however, these Customer actions have other Benefit options granted and/or redeem alternatives that can't co-exist with this Benefits option. Therefore several Benefit event alternative exists, which the customer needs to choose among them. At Group event, CAD contains several elements (Nc>1), BOD contains several elements (Nb>1), Several Benefit events alternatives exist, BOR is defined for each Benefit event alternative based on the BOD elements which are related to each Benefit event alternative. (Group event is illustrated in FIG. 3f. As can be seen for the 3 CAD elements, a Single-value Group event exits marked as E1 (while pursuing B2) and two single value events E2 & E3. Two benefit events alternative exists, E1 or a combination of E2 (while pursuing B1) & E3 (while pursuing B3). The first alternative BOR contains only B2, at the second alternative BOR contains B1 &B3).
Category 9: Time event is defined as a case where CAD elements are defined as all customer actions along a defined T time period (Nc>1). BOD elements are defined as all relevant Benefit options to the CAD elements. Time events can be divided into sub-events that match other Benefit event categories. Some of these Benefit events can co-exist and some not. Therefore, several Benefit events combination alternatives can exist; BOR is defined for each Benefit event alternative based on the BOD elements which are related to each Benefit event alternative.

### Benefit Event Categories CCV(E) Definitions

According to an embodiment of the invention, CCV(E) is defined as the CVV Index value of a specific Benefit event E. CCV methodology defines CCV(E) as the sum of CCV(B) index values of the Benefit options which are grant and\or redeem at a specific Benefit event (any Benefit event include single or several Benefit options). If n is the number of Benefit options, which includes at Benefit event E, using CCV(B) sum rule (equation 7), CCV(E) index value is defined as follow:

CCV(E)=Σₙ₌₁ⁿ(BVₙ*BGₙ*BRₙ)*Bwₙ−Σₙ₌₁ⁿBCₙ*Cwₙ=Σₙ₌₁ⁿBVₙ*Vfₙ−Σₙ₌₁ⁿBVₙ*Cfₙ Equation (8)

CCV(E) index value establishes a common comparison base for different Benefit event categories. CCV(E)'s index values are used to estimate and compare different Benefit event alternatives a specific customer has for a defined CAD.

In the following section, CCV(E) is defined for each of the above Benefit event categories.

### 1. Free Benefit

As was explained in the previous section, there is no Benefit event in the Free benefit case, as Customer action doesn't exist. Therefore, in this case, CCV(E)=0, which means that these Benefit options don't need to be estimated and compared to any other Benefit options while running Benefit events optimizations processes.

### 2. No Benefit

As was explained in the previous section, in the No benefit case, there is no Benefit event, as the Benefit option does not exist. Therefore, in this case, CCV(E)=0, which means that no Benefit options need to be estimated and compared to any other Benefit options while running Benefit events optimizations processes. (Although it seems trivial, No benefit cases are important to be recognized on some CCV Benefit options optimization processes).

### 3. Single Value Event

According to an embodiment of the invention, CCV(S) is defined as the CCV index value for a Single value event. As was explained in the previous section Single value event is defined as a case where a single Customer action has a single Benefit option the customer can grant and\or redeem. This Benefit option will be marked as B1. At a Single value event, only 1 Benefit event exists. This Benefit event will be marked as E1.

Single value event CCV(S) is calculated directly from CCV(E) equation (8) as follows:

CCV(S)=CCV(E₁)=CCV(B₁)=(BV₁*BG₁*BR₁)*Bw₁−BC₁*Cw₁=BV₁*Vf₁−BC₁*Cf₁ Equation (9)

### 4. Single Value Group Events

As was explained in the previous section, a Single value group event is defined as a case where several Customer actions have a single Benefit option the customer can grant and\or redeem. This Group of Customer actions is marked as G, and this Benefit option is marked as B1.

At a Single value group event, CAD needs to contain all the required customer actions to grant and\or redeem B1. CAD grouping rule is defined as the rule which defines G CAD elements (i.e., the Customer actions which are needed to grant and\or redeem B1). Usually, the Customer actions grouping rule is defined by the Benefits option (B1) grant and/or redeem conditions. (For example: 50$ coupon grant Benefit option, while a customer purchases at stoer #1 exceeding 800$ value. Based on this volume condition, the Customer actions grouping rule is all “customer purchases at store #1 till they exceed 800$ value).

According to an embodiment of the invention, CCV(G) is defined as the G CCV index value. In a Single value group event, only one Benefit event exists. This Benefit event will be marked as E1.

Single value group event CCV(G) is calculated directly from CCV(E) definition (Equation 8) as follows:

CCV(G)=CCV(E₁)=CCV(B₁)=(BV₁*BG₁*BR₁)*Bw₁−BC₁*Cw₁=BV₁*Vf₁−BC₁*Cf₁ Equation (10)

### 5. Multiple Value Event

As was explained in the previous section, a multiple value event is defined as a case where a Single Customer action or Several Customer actions can grant and/or redeem several (Nb) Benefit options in parallel. As these Benefit options are granted and\or redeemed in parallel, only one Benefit event exists. This Benefit event will be marked as E1.

According to an embodiment of the invention, at Multiple events for a Single customer event, CCV(S) is calculated directly from CCV(E) definition (Equation 8) as follows:

CCV(S)=CCV(E₁)=Σₙ₌₁^{Nb}CCV(Bₙ)=Σₙ₌₁^{Nb}(BVₙ*BGₙ*BRₙ)Bwₙ−Σₙ₌₁^{Nb}BCₙ* Cwₙ=Σₙ₌₁^{Nb}BVₙ*Vfₙ−Σₙ₌₁^{Nb}BVₙ*Cfₙ Equation (11)

At Multiple events for a group of several customer events (G), CCV(G) is calculated directly from CCV(E) definition (Equation 8) as follows:

CCV(G)=CCV(E₁)=Σₙ₌₁^{Nb}CCV(Bₙ)=Σₙ₌₁^{Nb}(BVₙ*BGₙ*BRₙ)Bwₙ−Σₙ₌₁^{Nb}BCₙ* Cwₙ=Σₙ₌₁^{Nb}BVₙ*Vfₙ−Σₙ₌₁^{Nb}BVₙ*Cfₙ Equation (12)

### 6. Repeated Value Group Event

According to an embodiment of the invention, a repeated value group event is a singular case of a multiple-value event. As was explained in the previous section, a Repeated value group event is defined as a case where Several Customer actions can grant and/or redeem the same Benefit option independently (in parallel) from each other. In this case, there are Nc CAD elements, each of which can grant and/or redeem the same Benefit option. This Group of Nc Customer actions is marked as G, and this Benefit option is marked as B1. As each of the Nc CAD elements can grant and/or redeem B1, there are Nc identical Benefit events. Repeated value group event CCV(G) is defined based on the CCV sum rule and using Equation (12) as follows:

$$CCV ( G ) = {\sum }_{n = 1}^{N c} C C V ( {E}_{n} ) = {\sum }_{n = 1}^{N c} C C V ( {B}_{1} ) = Nc * CCV ( {B}_{1} ) = Nc * ( {BV}_{1} * B {G}_{1} * B {R}_{1} * B {w}_{1} - B {C}_{1} * C {w}_{1} ) \qquad Equation ( 13 )$$

According to an embodiment of the invention, CCV(B) SUM rule is applicable only if different Benefit options are independent. In many repeated value group event use cases, there are dependencies among the occasions the Benefits option is granted and\or redeemed repeatedly (as will be explained hereinafter). In order to handle these cases, Repeated value group CCV(G) is transformed into a Single value Group event called the Equal Benefit option and marked as Be. Transformation is done by defining the Equal Benefit option CVV equation parameters as follows. Equal Benefit option BV and BC are defined as:

$$B e V = {\sum }_{n = 1}^{N c} ( B {V}_{1} ) = N c * ( B {V}_{1} ) \qquad Equation ( 14 )$$

$$BeC = {\sum }_{n = 1}^{N c} ( B {C}_{1} ) = N c * ( B {C}_{1} ) \qquad Equation ( 15 )$$

According to an embodiment of the invention, the Equal Benefit option BR defines as the probability that a specific customer will grant B1 Benefit option Nc times, marked as BeR. Equal Benefit option BG defines as the probability that this specific customer will redeem the Nc B1 Benefit options he granted, marked as BeG. Equal Benefit option weight factors are calculated based on the defined weight rules of this specific customer based on Bev, BeC, BeG, and BeR values. As the Equal Benefit option is a Single value Group event, only one Benefit event exists and is marked as Ee. CCV(G) at Equal benefit option event is defined as follows:

CCV(G)=CCV(Ee)=BeV*BeG*BeR*Bew−BeC*Cew=Nc(BV₁*BeG*BeR*Bew)−Nc(BC₁*Cew)=Nc*BV₁*Vef−Nc*BC₁*Cef Equation (16)

As can be seen from Equation (16), the Equal Benefit option CCV(Ee) introduces the repeated Benefit option grant and/or redeem dependencies into the CVV calculation by calculating BeG, BeR, Bew, Cew with relation to the number of times this benefit option is grand and\or redeem.

Equation (13) is a singular case of Equation (16). In such a case, there is no dependency between the repeated times B1 is granted and\or redeemed, BeG, BeR, Bew, Cew are identical to BG1, BR1, Bw1, and Cw1 correspondently.

According to an embodiment of the invention, on some occasions, there is a limit on how many times a Benefit option can be granted and/or redeemed by group Customer actions (G). If L is the maximum number of times Benefit option (B1) can be granted or redeemed by G, although G CAD contains Nc elements (every one of them can lead to B1 grant and\or redeem), B1 can be grant and\or redeem only L times. As a result, only L benefit events can co-exist. This case is defined as a Limited Repeated value group event.

According to an embodiment of the invention, Equation (16) can be used to calculate CCV(G) of Limited Repeated value group event. While BeR is defined as the probability that the specific customer will grant B1 Benefit option L times, BeG is defined as the probability that the specific customer will redeem the L B1 Benefit options he granted. As BeR & BeG values are changed, weight factors need to be recalculated as well. To distinguish between “Repeated value group event” and “Limited Repeated value group event” all CCV(G) equation parameters are market with upper tag (′). CCV(G) at Limited Repeated value group event is calculated as follow:

CCV(G)=CCV(Ee′)=BeV′*BeG′*BeR′*Bew′−BeC′*Cew′=L(BV₁*BeG′*BeR′*Bew′)−L(BC₁*Cew′)=L*BV₁*Vef′−L*BC₁*Cef′ Equation (17)

G CAD contains Nc element. However, in a Limited Repeated value group event, there're only L benefit events. It means that some of the G CAD elements (Nc-L) are not connected to any Benefit event. These customer actions can be excluded from G with no impact on customer Benefit options value. These Customer actions are defined as Non-value added customer actions at group G. Several customer actions exclude options from G are exist. If N is the number of the possible exclude options from G while maintaining L times of B1 grant and\or redeem than, there're N options to modify G CAD without impacting CCV(G) index value. G CAD excludes options are defined as GL1, GL2 . . . GLN. The CVV index value of all these G exclude options equals to CCV(G) as reflected in the following Equation:

$$CCV ( G ) = CCV ( {G}_{L 1} ) = C C V ( {G}_{L 2} ) = … = CCV ( {G}_{L N} ) = C C V ( {Ee}^{′} ) = {BeV}^{′} * {BeG}^{′} * {BeR}^{′} * {Bew}^{′} - {BeC}^{′} * {Cew}^{′} = L ( B {V}_{1} * {BeG}^{′} * {BeR}^{′} * {Bew}^{′} ) - L ( B {C}_{1} * {Cew}^{′} ) = L * {BV}_{1} * {Vef}^{′} - L * B {C}_{1} * {Cef}^{′} \qquad Equation ( 18 )$$

As can be seen from Equation (18), choosing among the different exclude options doesn't have any impact on CCV(G) index value. The reason is that as a repeated value group event was defined as a case that for all the G CAD elements, only B1 exists in the BOD. However, for Group events (as will be discussed in the following sections) where BOD contains several elements, CCV(GLn) index value depends on which G Customer actions were excluded from G. CCV(GLn) index value comparison between the different GLn definition options have a significant role in CCV methodology benefit optimization processes.

Repeated limits are usually defined by the Benefit options provider. However, in some cases, a Customer may want to define a limit on how many times he would like to Grant and\or Redeem a specific Benefit option. In such a case, L will be defined by the Customer, and CCV(G) will be calculated using Equation (18) based on the Customer limit. The customer limit can be an outcome of volume or time targets a customer has. Such limitations are defined as Customer Personalize conditions. By translating customer targets into Personalized conditions and then to CCV(GLn) index value, customer desires are incorporated into the CCV methodology benefit optimization processes. Equal Benefit options, as an interpretation of Repeated value group events, have an important role in the CCV methodology. In today's marketplace, there are many repeated Benefit options programs in which the ability to grant and\or redeem their Benefit options depends on the number of times this Benefit option was granted. Using the Equal Benefit option approach allows integrating these Benefit options programs into personalized CCV calculations and Benefit options optimization processes.

### 7. Single Action Event

On the six previous categories, the benefit options didn't compete among them. Either only one benefit option exists in the BOD, or several benefit options can be granted and/or redeemed in parallel. In the following categories, there is a need to make tradeoffs between possible Benefit events alternatives as some of the Benefit options can't co-exists for the CAD elements. Each Benefit event alternative contains a different Benefit option/s. Benefit events alternatives CCV(E) index values can be used to compare between the Benefit events alternatives. CCV methodology defines the Benefit event alternative with the highest CCV(E) index value as the most beneficial alternative for the specific customer. This Benefit event is defined as a Preferred Benefit Event (PBE).

According to an embodiment of the invention, calculating the CCV(S) of a single action requires mapping of all the benefit events alternatives. If N benefit events alternatives exist, CCV(S) is defined as follows:

$$CCV ( S ) = CCV ( PBE ) = {max}_{1 \leq n \leq N} CCV ( En ) \qquad Equation ( 19 )$$

### 8. Group Event

As was defined in the previous section, a Group event is defined as a case where several Customer actions can grant and/or redeem a specific Benefit option. This Benefit option is defined as the Origin benefit option. However, these Customer actions have other Benefit options grant and/or redeem alternatives that can't co-exist with the Origin benefit option. As a result, several Benefit events alternatives to the Origin Benefit event exist. In a similar way to a Single event, to calculate CCV(G), there is a need to map all the Benefit events alternatives for G CAD elements.

The group event Benefit events alternatives mapping process is much more complicated than the Single event mapping process. According to an embodiment of the invention, besides the origin benefit option, there is a need to map which G CAD elements are related to each Benefit options and define their Benefit Events. Then there is a need to map the possible combination of different Benefit events for G and combine them into Multiple value events. In case one of the Benefit event alternatives is a Limited Repeated value group event, the mapping process is even more complicated as several alternatives exist among the G CAD elements, and therefore Equal benefit option CCV parameters and weight factors are needed to be recalculated for each one of them.

According to an embodiment of the invention, Ec is defined as a Benefit event alternative for the G CAD element. If the mapping process defines i possible Benefit event alternatives, CCV(Ec) is calculated for each one of them, resulting in i CCV(Ec) index values. CCV(G) is defined as follows:

$$CCV ( G ) = CCV ( PBE ) = {max}_{1 \leq n \leq i} CCV ( E cn ) \qquad Equation ( 20 )$$

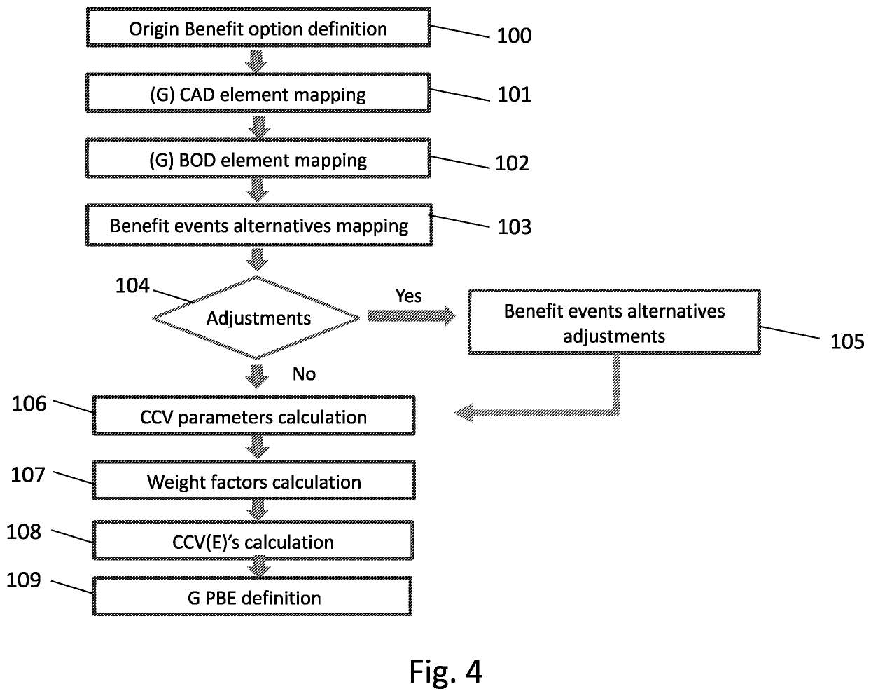

FIG. 4 shows CCV(G) calculation flow, according to an embodiment of the invention. At the first step (100), the origin benefit option is defined. On the following steps (101), the related Customer actions to the origin benefit option are defined as (G) CAD elements, and (102) all relevant benefits options to these (G) CAD elements are mapped and defined as (G) BOD elements. At the next step (103), all the possible Benefit event alternatives are mapped. At this step in the process (104), a decision needs to be made whether to perform some adjustments to the mapping results (105), like: applying Equal Benefit, applying customer personalize conditions, Alternatives elimination, etc. Based on the benefit events mapping (adjust or not adjust), CCV parameters (BV, BC, BG, BR) (106) and weight factors (107) are calculated for every benefit option in (G) BOD. At the final steps, CCV(E) is calculated for every mapped benefit event (108). The benefit event with the highest CCV(E) value is defined as the G PBE (109).

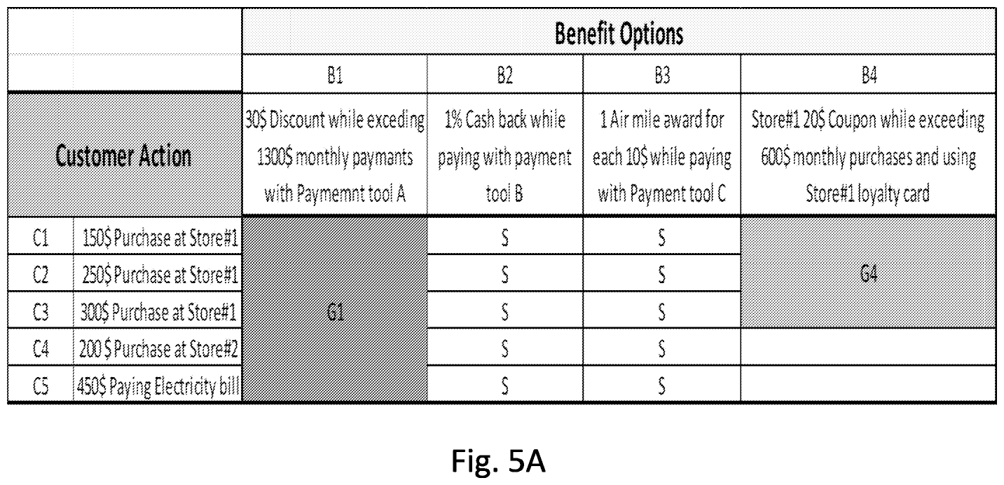

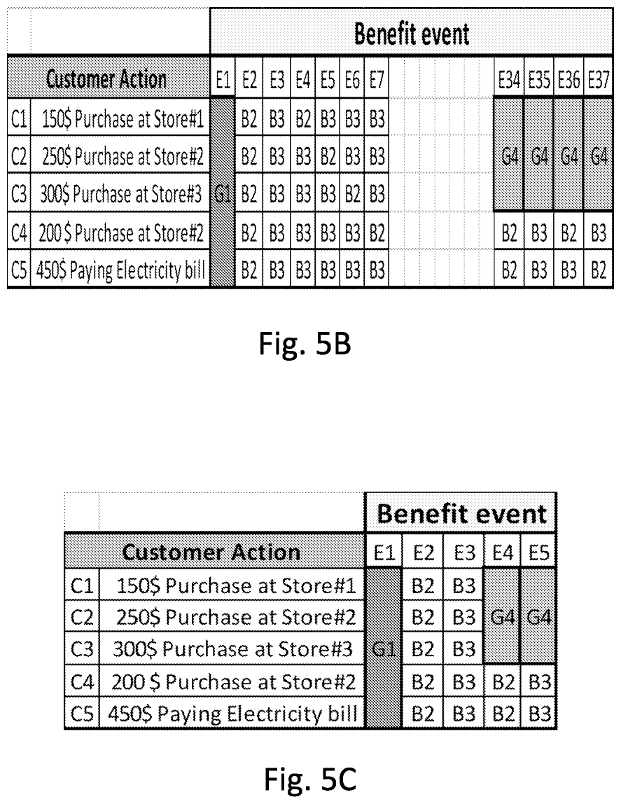

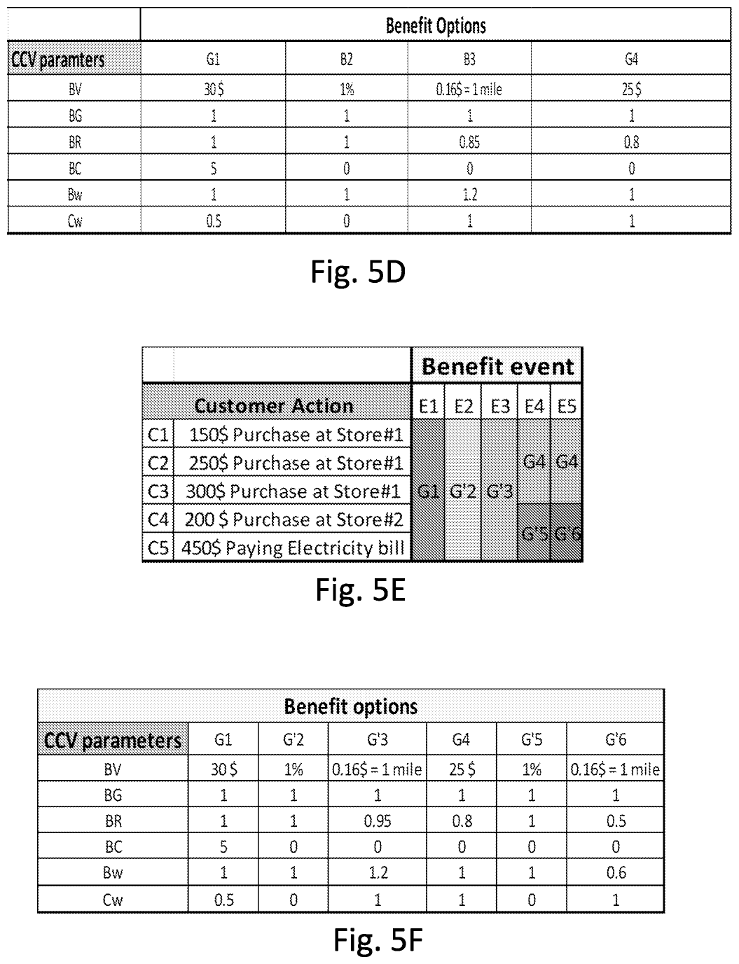

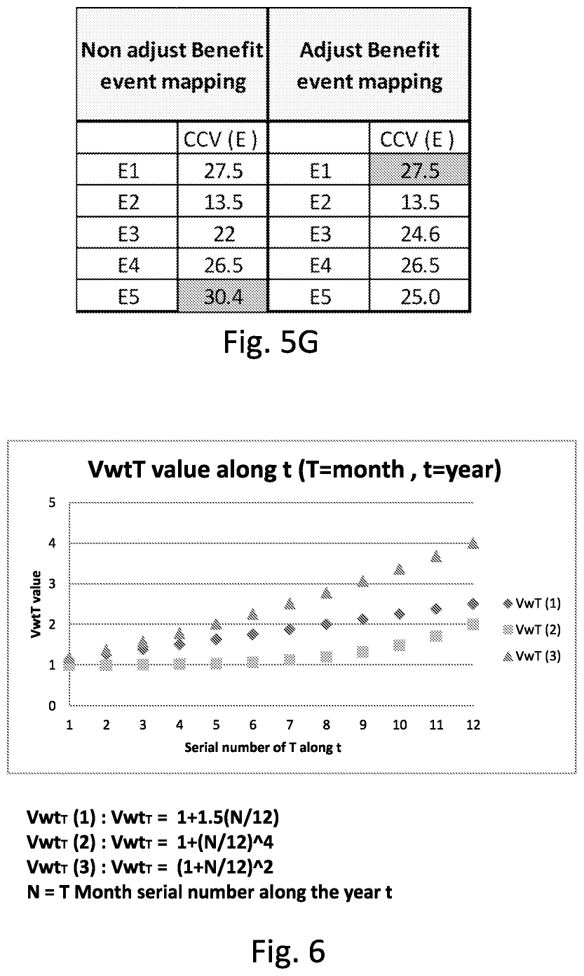

The above will be better understood through the following illustrative and non-limitative examples of the Group event CCV(G) calculation process with respect to FIGS. 5A-5G

FIG. 5A demonstrates the first three steps of the CCV(G) calculation process (100,101 &102 at FIG. 4), according to an embodiment of the invention. The Origin Benefit option (B1) is a 30$ discount while Monthly payments with a payment tool A exceed 1300$. B1 (G) Grouping rule is a volume (Exceeding 1300$ payments) and time (monthly) conditions. Based on the Origin benefit Grouping rule, (G) CAD elements are defined (Nc=5). These customer actions are listed in column B (marked as C1, C2, C3, C4, C5). These five customer actions fulfill the Origin benefit grouping rule conditions as they occur in the same month and exceed 1300$ payments value when the customer is using payment tool A while making these Customer actions. Then (G) BOD is defined. Three additional Benefit options (B2, B3, B4) that are related to G CAD elements are mapped (Nb=4). Benefit option #2 (B2) is a 1% Cashback while paying with payment tool B. Benefit option #3(B3) is 1 Air mile award for each 10$ while paying with Payment tool C. Benefit option #4 (B4) is, Store #1 25$ Coupon while exceeding 600$ monthly purchases and using Store #1 loyalty card. Relevant (G) CAD elements for each one of the (G) BOD elements are identified and categorized (C1-C5 are single value events for B2 & B3, B4 is a group event of C1-C3).

The following step, the Benefit events alternatives mapping process (103 at FIG. 4), is demonstrated in FIG. 5B. At this step, all Benefit events alternatives between (G) CAD elements and (G) BOD elements are defined, taking into consideration the Benefit options tradeoffs. B1 as the Origin benefit option defines the Origin Benefit event E1. B2 & B3 are Single value event Benefit options. There are 32 Combinations on B2 & B3 among the five (G) CAD elements reflecting 32 Customer events alternatives. B4 is a Group Benefit option with a grouping rule of “Exceeding 600 monthly purchase at stoer #1”. B4 Grouping rule can be fulfilled only by C1,C2 & C3 together. Therefore C1,C2 & C3 are defined as (G4) CAD. As C4 & C5 are part of (G) CAD but not contained in (G4) CAD while approaching B4, C4 & C5 can Grant and\or Redeem B2 or B3. 4 Combination on B2 & B3 among C4 & C5 elements reflects four Customer events alternatives. Therefore, a total of 37 Benefit events options exists for (G) CAD and BOD elements, as is seen in FIG. 5B.

At this step in the process, a decision needs to be made whether to adjust the Benefit events alternatives mapping from the previous step or not (104 at FIG. 4). The adjustment step is optional (105 at FIG. 4). For example sake, two adjustment methods are demonstrated. The first one aimed to ease the following calculation by applying some quick alternatives comparison and elimination analysis. 37 Benefit events alternatives were mapped, however, as B2 & B3 have the same CCV parameters for all (G) CAD elements, Either B2 or B3 having a higher value for each Customer action. Therefore the preference between B2 or B3 is the same for all (G) CAD elements. Therefore to define PBE, it is sufficient to compare the Benefit events where either B2 or B3 are granted or/and redeemed for all (G) CAD elements. The same argument is valid for C4&C5 at the Benefit event, which contains B4. In such a way, the amount of Benefit events that need to be compared to determine CCV(G) is reduced from 32 to only five, as can be seen in FIG. 5C.

Handling 5 Benefit events alternative rather than the 37 Benefit events alternatives in the following steps simplify the following steps.

The second adjustment method demonstrated in this example is applying for Equal benefits. Taking the first adjustment step results, E2 & E3 contains a sequence of repeated value benefit options of B2 & B3. Equal Benefit options are defined for these sequences signed as G′2 & G′3, respectively. In the same way, Equal Benefit options G′5 & G′6 are defined for the repeated value benefit options of B2 & B3 at E4 & E5. Results of applying Equal benefit options are shown in FIG. 5E demonstrates the Benefit events alternatives adjusted scheme as a result of both adjustment steps.

Upon the Benefit events alternatives schemes definitions, on the following steps, CCV(B) parameters and Weight factors are calculated for each of the different Benefit options, which are combined these Benefit event alternatives (106 & 107 at FIG. 4). FIG. 5D demonstrates CCV parameters and Weight factor for FIG. 5C Benefit event alternatives scheme. B1, B2, B2, and B4 CVV parameters are listed in columns C, D, E &F as well. BG is 1 for all as Grant conditions are fulfilled for all Benefit options by the (G) CAD elements. BR for B1 & B2 is 1 as the Benefit options are redeemed in real-time. For B3, the Air miles redeem probability (B3R) was calculated as 0.95. For B4, the Coupon redeemed probability (B4R) was calculated as 0.8. Payment tool #1 have a monthly cost of 5$ while other Benefit options have no associate cost. As the grant and redeem probabilities are high, no significate weight rules were applied due to Grant or Redeem risk levels. Air miles are the customer favorable Benefit options and therefore B3 Bw=1.2. B1 Cw is defined as 0.5 as the payment tool #1 cost is not related just to the B1 Benefit option. Other Benefit options have no associated cost, and therefore, Cw is not relevant to them and was defined as 1.

FIG. 5F demonstrates CCV parameters and Weight factor for FIG. 5E Benefit event alternatives scheme, according to an embodiment of the invention. G′2 & G′5 have equaled CCV parameters and weight factors values parameters to B2, as there is no meaning to the fact that B2 is repeated several times on B2 Grant or Redeem probabilities. G′3 & G′5 are Equal benefit options of B3. As the number of the Granted Air miles has a direct influence on this Benefit option redeem probability (Having more Air miles can allow the customer to achieve the Redeem volume condition easier), G′3 & G′5 Redeem probability is different from B3. G′3 as it represents 1350 Air miles, and therefore, its redeem probability is higher than B3 redeem probability and was calculated to be 0.95 (while B3 BR is 0.85). On the other hand, G′5 represents only 650 Air miles in this specific case; based on the customer data, the Redeem probability is lower and was calculated as 0.5. The customer defines a weight rule of Rw=0.5 for BR<=0.5 and therefore G′S Bw=0.6 (G′5 Bw=1.2*1*0.5).

In the last steps, CCV(E) is calculated for each of (G) Benefit events alternatives (108 at FIG. 4). The Benefit event with the highest CCV(E) index value is defined as CCV(G) and PBE (109 at FIG. 4). FIG. 5G shows CCV(E) index values for each Benefit events alternatives on both scenarios with and without applying Equal Benefit adjustment. As can be seen, when Equals Benefits as not applied, E5 is the Benefit event alternative with the highest CCV(E) index value, therefor E5 is the PBE. When Equals Benefits are applied, E1 is the Benefit event alternative with the highest CCV(E) index value, therefor E1 is the PBE. These results demonstrate how using the Equal benefit definition can change the CCV's index values calculation and, as a result, the decision made based on them.

### 9. Time Event

A time event is a group event with a defined Time period as a grouping rule. Unlike the group event where (G) grouping rule is defined by the Origin benefit, (T) grouping rule is not connected to any specific benefit option but to a time period. T CAD contains all the Customer actions at a specific time period T. T BOD contains all related Benefit options to the T CAD elements. Similar to a group event, several Benefit event alternatives can exist for (T); each one of them reflects a different possible Benefit options combinations. Ec is defined as an alternative combination of Benefit events for the T CAD element. If the mapping process defines i possible Benefit event alternatives, CCV(Ec) is calculated for each one of them, resulting in CCV(Ec) index values. CCV(T) is defined as follows:

$$CCV ( T ) = CCV ( PBE ) = {max}_{1 \leq n \leq i} CCV ( E cn ) \qquad Equation ( 21 )$$

In case of time event, T BOD may contain Benefit options whose time dependency is not aligned to T time period (shorter or longer than T). These Benefit options need to be adjusted to T in order to calculate CCV(T). At the first step, there is a need to consider the time period inconsistency while calculating these Benefit options relative to CCV(B) index values for the T time period. CCV(Bt)T is defined as the CCV(B) index value of a Benefit option with time dependency period t at time period T. At the second step, CCV(T) is calculated using CCV(Bt)T index value for these T BOD Benefit options, which their time dependency is not aligned to T time period (shorter or longer than T).

Based on Equation (2), CCV(Bt) T is defined as:

CCV(Bt)_{T}=(BVt_{T}*Vwtₜ)*(BGtₜ*Gwt_{T})*(BRt_{T}*Rwt_{T})−(BCt_{T}*Cwt_{T}) (Equation 22):

In case a Benefit option has t>T (longer time period dependency than T), in order to calculate CCV(Bt)T, the relative Benefit option value and relative Benefit option cost are defined as follows:

$$B V {t}_{T} = ( BV * \frac{T}{t} ) \qquad ( Equation 23 )$$

$$BC {t}_{T} = ( B C * \frac{T}{t} ) \qquad ( Equation 24 )$$

Relative Grant and Redeem probabilities (BGtT,BRtT) and relative weight factors (VwtT, GwtT, RwtT, CwtT) need to be calculated as well.

According to an embodiment of the invention, there are several options to calculate the relative Grant and Redeem probabilities (BGtT, BRtT) and relative weight factors (VwtT, GwtT, RwtT, CwtT) values.

The Pure relative approach refers to the relative portion of the Benefit option at time period T, as a standalone Benefit option at T. Therefore, relative Grant and Redeem probabilities (BGtT, BRtT) and relative weight factors (VwtT, GwtT, RwtT, CwtT) values are calculated with no connection to other T periods contains in t.

The Cumulative approach refers to the Benefit option grant history and their impacts on future redeem probability while calculating BGtT and BRtT. BGtT is calculated with reference to previous T periods and the time left to t end. Therefore, BGtT is calculated as the probability to grant the Benefit option by the end of t, based on current grant condition fulfillment (from the beginning of t time period). BRtT is calculated as the probability to redeem the benefit option at t end, considering the current grant status. Weight factors are calculated based on BVtT, BGtT, BRtT, BCtT values, and customer weight rules.

The Enhanced Value approach refers to the fact that failing to grant and/or redeem the portion of the benefit options at T leads to a loss of the value of the Benefit option portion, which was granted up to now. By applying a higher Benefit value weight factor (VwtT) at the last stages oft, CCV(Bt)T gets a higher index value as the t end is closer. VwtT is calculated by referring to the time which passed from the beginning oft till T, and to the time which left to the end of T. FIG. 6 is demonstrating three optional algorithms to calculate VwtT in order to enhance BVtT impact on CCV(Bt)T index value as T is closer to the Benefit option Grant or\and redeem date which depends on t. As can easily be seen, each of the algorithms represents a different enhancement magnitude.

In some cases, several combinations of the above approaches can be used, according to an embodiment of the invention.

The above will be better understood through the following illustrative and non-limitative examples. May B be a Yearly time dependency (t=year) Benefit option. B Benefit value (BV) is 1200$, and a redeem condition of granting 1200 award points along the year exists and no cost associated with this benefit option. T is a Month time period along; for example, we will define T as the 8^{th} month along t year time period. T BOD contains B, which means that some of the Customer actions in T CAD can lead to granting B award points. In order to calculate CCV(T), there is a need to calculate the CCV(Bt)T index value of these B award points. Based on equation 23, BVtT is 100$. Based on equation 24, BCtT is 0. As Pure relative approach refers to the relative portion of the Benefit option at time period T, as a standalone Benefit option at T. Therefore, BGtT is calculated as the probability to grant 100 award points at the current month (T). BRtT is calculated as the probability to redeem this Benefit option at the end of the year(t). CCV(Bt)T Weight factors are calculated based on BVtT, BGtT, BRtT, BCtT values, and customer weight rules.

As Cumulative approach refers to the Benefit option grant history and its impact on future redeem probability. For example, we will assume two scenarios. In the first one, the customer has been granted 1000 award points since T beginning up to now (in the last seven months). In the second one, the customer granted only 500 award points since T beginning up to now (in the last seven months). In the first scenario, BGtT is calculated as the probability that the customer will grant 200 award points during the following five months. BRtT is calculated as the probability to redeem this Benefit option at the end of the year(t), knowing that 1000 award points were already granted. In the Second scenario, BGtT is calculated as the probability that the customer will grant 700 award points during the following five months. BRtT is calculated as the probability to redeem this Benefit option at the end of the year(t), knowing that only 500 award points have been granted up to now. It is clear that BGtT in the first scenario will be greater than in the second one. A combined Cumulative and Pure Relative approach can be used as well. In such case, in the first scenario, BGtT is calculated as the probability that the customer will grant 40 (200/5) award points during the next month, T. In the second scenario, BGtT is calculated as the probability that the customer will grant 140 (700/5) award points during the next month, T.

As the Enhanced Value approach refers to the fact that it is failing to grant and/or redeem, the portion of the benefit options at T leads to a loss of the value of the Benefit option portion, which was granted up to now. For example, we will use the second algorithm in FIG. 6. As can be seen, VwtT=2 for the 8^{th} month along t. By applying a weight value on the B award points value during the T month period, CCV(T) alternatives that contain B will get a higher CCV(T) index value. The Enhance Value approach can be combined with Pure relative and/or Cumulative approaches by using BGtT and\or BRtT values which were calculated according to these approaches.

In case t<T (Shorter time period). In case B Benefit option can be granted and\or redeemed only once along T. CCV(B) is calculated as a Single value event or Single value group event. In a case, the B Benefit option can be granted and\or redeemed several times (N) along T. CCV(B) is calculated as Limited repeated value group event with N as the repeating limit.

In a case, the B Benefit option can be granted and\or redeemed several times (N) along with T, while the last grant and\or redeem occasion (N+1) is partially at T and partially beyond T but still in t. CCV(B) is calculated as the sum of a Repeated value group event with N repetitions of B and a relative B which has t>T1, as follows:

$${CCV ( Bt )}_{T} = {\sum }_{n = 1}^{N} CCV ( B ) + {CCV ( Bt )}_{T 1} \qquad Equation ( 25 )$$

$$While : T = N * t + x * t , x = ( \frac{T}{t} - N ) , T 1 = x * t$$

According to an embodiment of the invention, In case of a benefit option have only Grant and/or redeem volume condition, this condition need to be translated into a combined time and volume condition and by that define a time dependency which will allow to incorporate this benefit option in CCV(T) calculation. Such condition is created by adding a time target to fulfill this Benefit Grant and/or redeem volume condition, although the Benefit option provider didn't define a time fulfill limitation. The time limit can be defined by the customer (defining when he is willing to grant and\or redeem this benefit option) or by the statistical analysis calculating this benefit option grant and/or redeem fulfillment time based on historical data or any other logical algorithm.

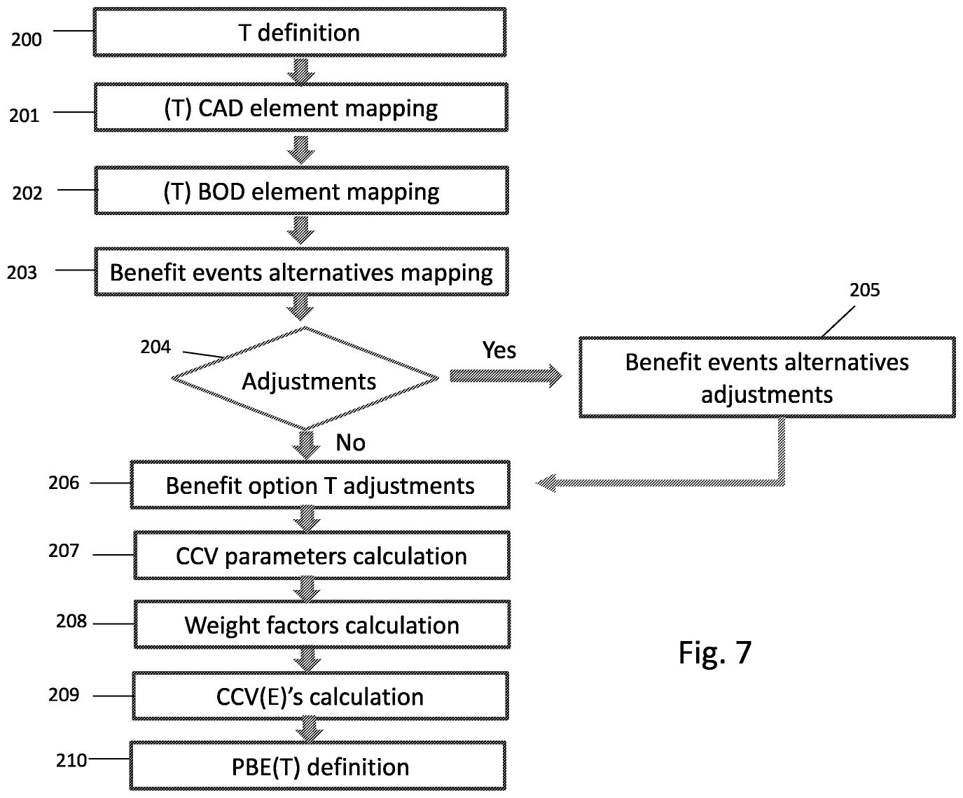

FIG. 7 shows CCV(T) calculation flow, according to an embodiment of the invention. At the first step (200), the Time period T is defined. On the following steps (201), the related Customer actions to the Time period T are defined as (T) CAD elements and (202) all relevant benefits options to this as (T) CAD elements are mapped and defined as (T) BOD elements. At the next step (203), all the possible Benefit event alternatives are mapped. At this step, in the process (204), a decision needs to be made if to perform some adjustments to the Benefit event alternatives mapping results (205), like: applying Equal benefit, Applying customer personalize conditions, Alternatives elimination, etc. As the benefit events mapping (adjust or not adjust) is defined, all the Benefit options included in (T) BOD are adjusted to T (206) using above methods (t to T comparison, Pure relative approach, Cumulative approach, Enhanced Value approach, etc.). Then CCV parameters (BVtT, BGtT, BRtT, BCtT) (207) and weight factors (VwtT, GwtT, RwtT, CwtT) (208) are calculated for every benefit option in (T) BOD. At the final steps, CCV(E) is calculated for all mapped benefit event alternatives (209). The benefit event alternative with the highest CCV(E) value is defined as the T PBE (210).

Time event and CCV(T) index value have a major role in applying CCV methodology due to the fact that many Benefit options have grant and\or redeem time period dependency (Monthly, Yearly, etc.).

### CCV Methodology Benefit Optimization Approach

### Customer Profiling Process:

According to an embodiment of the invention, the Customer Profiling process is a retroactive CCV(T) calculation process that uses historical customer data to identify PBE(T) patterns and validate customer CVV parameters and Weight factors for different Benefits options. Incorporating personalization elements into the Customer Profiling process identify ways to match customer's personal factors. The profiling process products are: “T Customer profile”, “Vf(T) Profiled matrix”, and “Cf(T) profiled matrix”. “T Customer profile” is defined as PBE(T) Benefit option combination, which represents the most valuable grant and\or redeem Benefit options combination for a specific customer at T. Using equation (6), Vf & Cf values are calculated for each Benefit option in BOD(T). As the profiling process runs on actual historical data (rather than predicted future statistical data), these Vf & Cf values can be validated against each Benefit event's alternative real CCV(E) value and PBE(T). Validated Vf & Cf values are captured in “Vf(T) Profiled matrix” and “Cf(T) profiled matrix”.

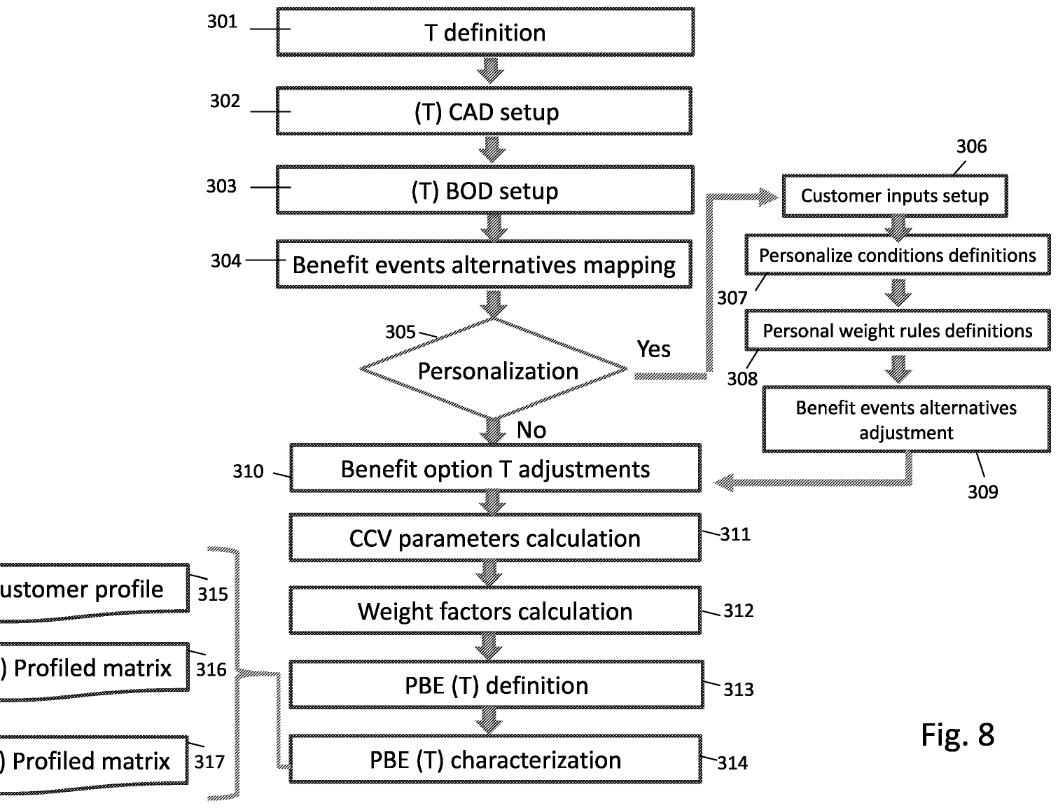

An example of a Customer profiling process flow is shown in FIG. 8, in accordance with an embodiment of the invention. At the first steps, T is defined (301), all T time period Customer actions are captured into (T) CAD (302), and (T) BOD is created (303) by mapping all relevant Benefit options for (T) CAD elements. Then using CVV methodology methods (like: Benefit option categories, Equal benefit definitions, Multiple and limited Benefit options, etc.), all Benefit events alternatives for (T) CAD elements are mapped (304). At this step in the process (305), a decision needs to be made to introduce some customer personalization elements into the profiling process (or not). The personalization stage goal is to capture customer characteristics into the profiling process in order to enhance “T Customer profile”, “Vf(T) Profiled matrix” and “Cf(T) profiled matrix” matching customer Benefit options preferences and risk profile. (Personalization stage is optional. However, running the profiling process without personalization significantly reduces the Personalize Benefit options optimization processes effectiveness, which relies on the Profiling process outcomes). If a decision to add Personalization to the process is made, then needed customer inputs are defined and collected (306). At the following step (307), based on customer inputs, Benefit options grant and/or redeem targets are translated into “Personalized customer conditions”. Then, customer weight rules are defined (308) based on customer Benefit options priorities and risk profile definitions. All the personalization inputs Adjust Benefit event alternatives scheme is crated (309) to reflect customer personalization inputs. As the benefit events scheme (personalized or not personalized) is defined, all the Benefit options included in (T) BOD are adjusted to T (310). CCV parameters (BV, BC, BG, BR) (311) and weight factors (Vw, Cw, Gw, Rw) (312) are calculated for every benefit option in (T) BOD. Using calculated CCV parameters and weight factors, CCV(E) index value is calculated for each Benefit event alternative, and PEB(T) is defined (313). By characterizing PEB(T) (314), “T Customer profile” (315), “Vf(T) Profiled matrix” (316), and “Cf(T) profiled matrix” (317) are captured.

According to an embodiment of the invention, several approaches can be used to calculate Weight factors (Vw, Cw, Gw, Rw) at the Customer profiling process. On the Direct Weight rules translation approach, Weight factors are calculated directly from the weight rules, which were defined by the Customer at the Personalization stage or based on defined weight rules schemes. Empiric weight factors value calculation approach. Relying on customer historical T data, the real benefit value of each Benefit event alternative is calculated. Then several Weight factors schemes are validated and adjusted to achieve the best fit between the different Benefit events CCV(E) index and their calculated real Benefit value. As long as this comparison process runs, the confidence level in Empiric weight factors values increases. Empiric weight value calculation is executed using a variety of analytical computing tools and patterns calculations methodologies, such as Advance algorithms, Artificial Intelligence, Machine learning engines, etc. Both approaches can be combined into a Combined approach where some of the Weight factors are defined by Weight rules and some by Empiric calculation based on each benefit option characteristic.

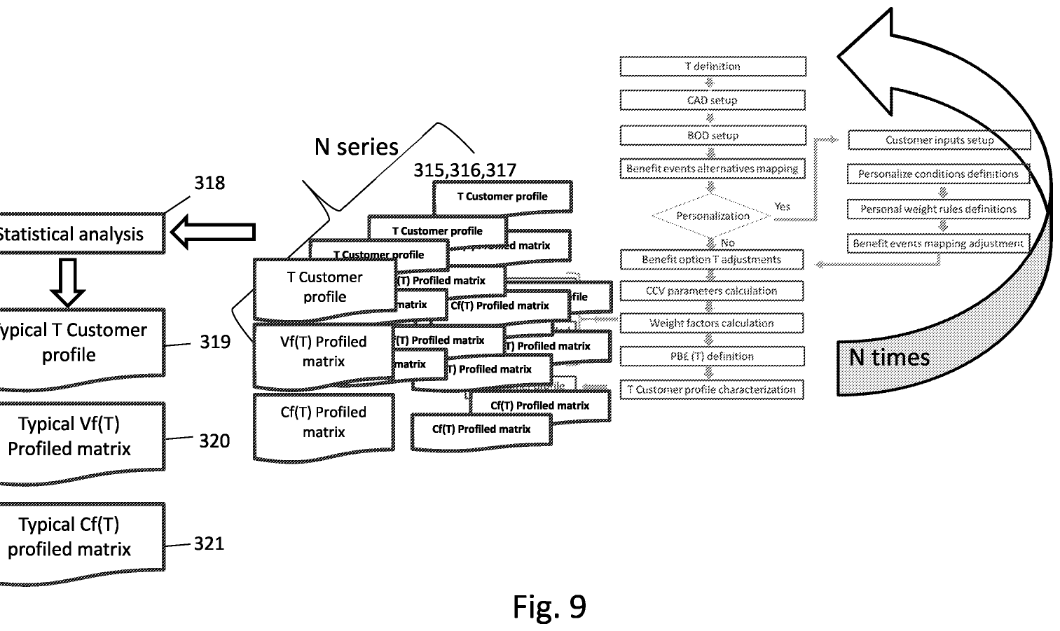

According to an embodiment of the invention, repeating the customer profiling process over a sequence of T time periods produce a series of “T customer profile”, “Vf(T) Profiled matrix” and “Cf(T) profiled matrix”. Applying statistical analysis methods on these series creates “Typical T customer profile”, “Typical Vf(T) Profiled matrix” and “Typical Cf(T) profiled matrix”. The more T time periods the Profiling process is performed for, “Typical T customer profile”, “Typical Vf(T) Profiled matrix” and “Typical Cf(T) profiled matrix” accuracy increase. Repeated Customer profiling process flow is shown in FIG. 9. Performing the Customer profiling process for N “T time periods” produces N series of “T customer profile”, “Vf(T) Profiled matrix” and “Cf(T) profiled matrix”. Applying statistical analysis methods on these N series (318) produce “Typical T customer profile” (319), “Typical Vf(T) Profiled matrix” (320), and “Typical Cf(T) profiled matrix” (321).

### Personalize Benefit Options Optimization Process

According to an embodiment of the invention, the Customer profiling process outcomes “Typical T customer profile”, “Typical Vf(T) Profiled matrix” and “Typical Cf(T) profiled matrix” are used to guide the customer on how to execute a current Customer action in real-time at a way that he will get the highest value from all his Benefit options alternatives along the defined T time period.

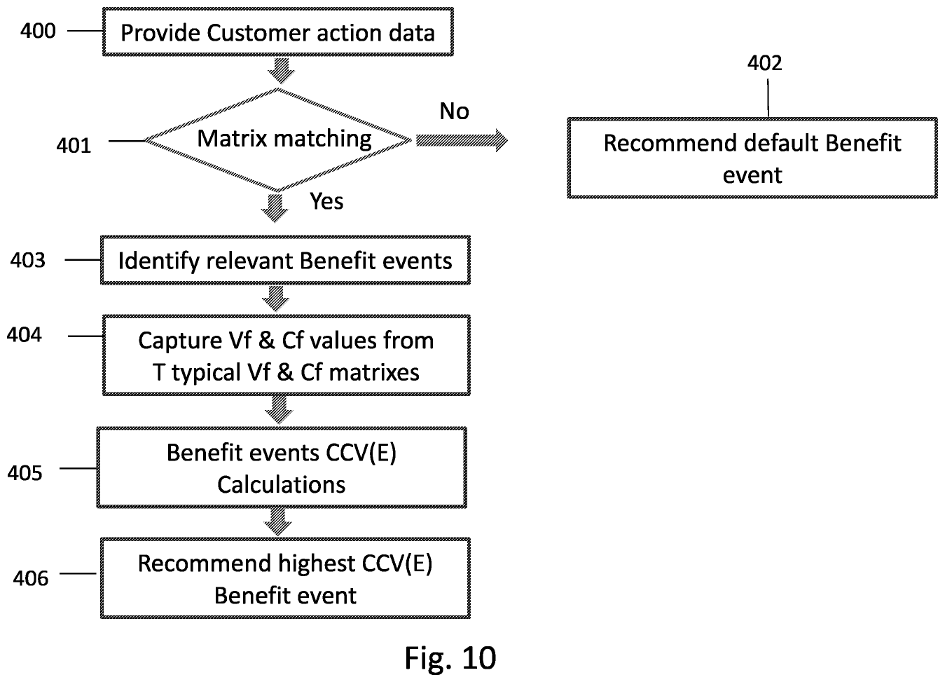

According to an embodiment of the invention, the Personalize Benefit options optimization process Factors approach is based on the “Typical Vf(T) Profiled matrix” and “Typical Cf(T) profiled matrix”. As a Customer action is about to occur CCV(E) index value is calculated for all relevant Benefit events for this action. The Benefit event with the highest CCV(E) index value is recommended to the customer. An example of the Factors approach Personalize Benefit options optimization process is shown in FIG. 10. Customer action data is captured upon a Customer action is going to be executed (400), the data is verified against the list of the Benefit events in the “Typical Vf(T) Profiled matrix” and “Typical Cf(T) profiled matrix”(401). If the Customer action doesn't match any of the Benefit events these matrixes are referred to; then a default Benefit event is recommended (402). If there is matching, all the relevant Benefit events alternatives for this Customer action are identified (403). Then for each of the relevant Benefit events alternatives, Vf & Cf values are captured from the “Typical Vf(T) Profiled matrix” and “Typical Cf(T) profiled matrix” (404). Using these Vf & Cf values, CCV(E) indexes are calculated for all the relevant Benefit events alternatives (405). The Benefit event with the highest CCV(E) is recommended (406). Consistently executing for all the customer actions at the current T period, the highest CCV(E) Benefit event alternative leads to customer Benefit options optimization at the whole current T period.

According to an embodiment of the invention, the Benefit options optimization Profile approach is based on the “Typical T customer profile”. Converting “Typical T customer profile” to a set of rules and targets creates an action plan for the customer along the T time period (For example: Spending above xx $ using payment tool A, Use customer membership card for all purchases at sores A & B, etc . . . ). This plan is defined as a T action plan. Following “T action plan”, leads current T period Benefit events execution to close match to “Typical T customer profile” and as results achieve benefit events optimization on current T period. “T action plan” execution matching to “Typical T customer profile” is monitored along the current T period. The monitoring process is performed several times along the current T period, at defined time intervals. When a deviation from the T action plan is found, the T action plan is modified in a way this deviation will be corrected, or at least minimized, till the end of the Current T period.

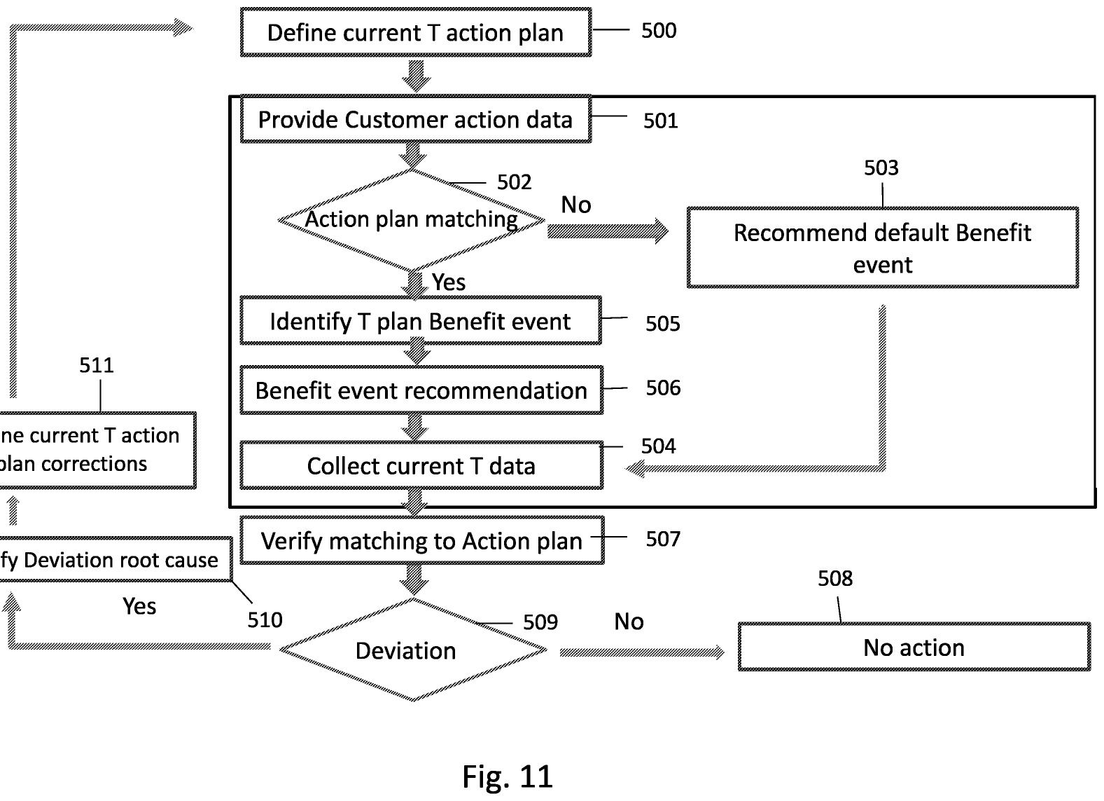

An example of the Profile approach Personalize Benefit options optimization process is shown in FIG. 11, according to an embodiment of the invention. At the first step (500) current T action plan is defined based on the “Typical T PBE scheme”. Customer action data is captured upon a Customer action is going to be executed (501), the data is verified against the T action plan (502). If this Customer action doesn't match any rule or target in the T action plan, a default Benefit event is recommended (503). If there is matching, the match T action plan Benefit event is identified (505) and recommended (506). The way each customer action was executed along the current T period is collected (504). On defined time intervals along the current T period, the matching to the T action plan is verified (507). If execution fits the “T action plan”, no action is required (508). In a case deviation is recognized (509), an analysis is run to identify the deviation root cause (510) and define needed current T action plan corrections in order to match “Typical T PBE scheme” at the rest of the current T period (511). Based on these analyses, the current T action plan is modified (500). Next, customer actions will be executed based on the modified T action plan till the end of the current T period. Part of Benefit options optimization Profile approach process steps occurs in real-time (501-506) while the Customer action is taking place, and some off-line (500,507-510).

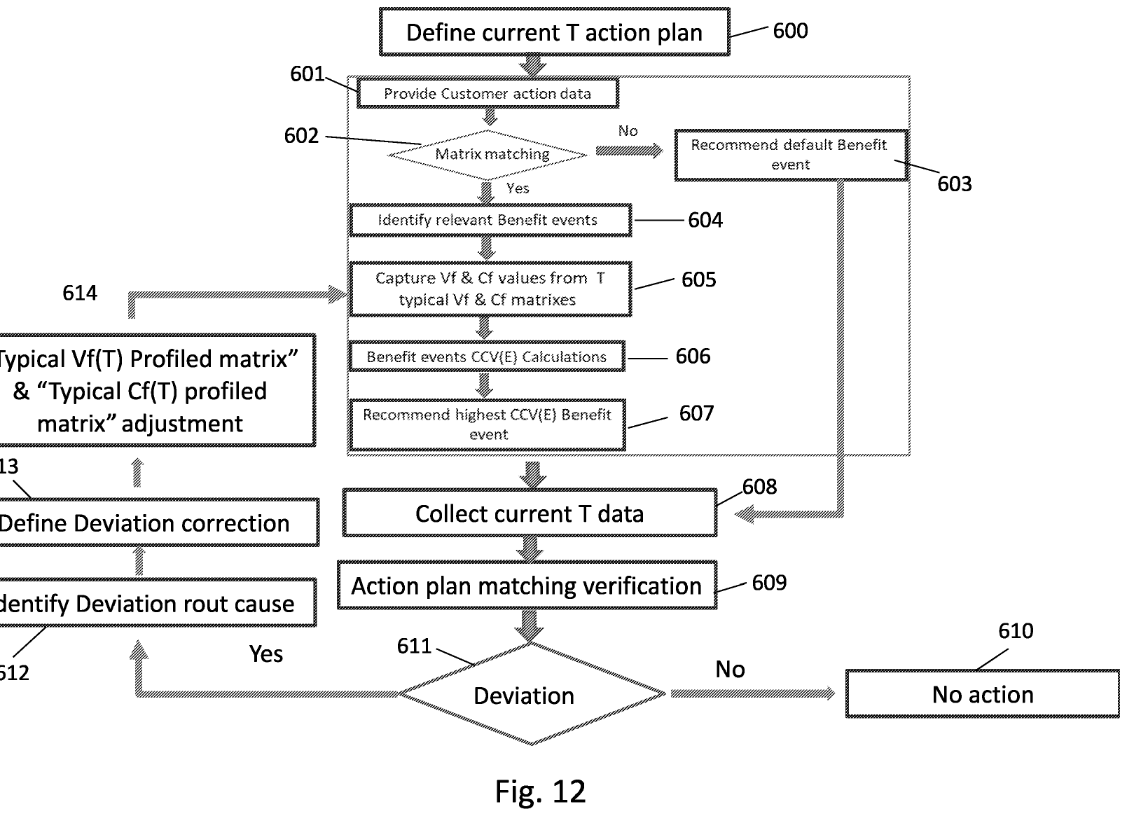

In some embodiments, a combination of the Factor approach and Profile approach is implemented. A possible combination is performing the off-line steps using the profile approach and the real-time steps using the Factor approach. An example for the Combined Factor approach and Profile approach Personalize Benefit options optimization process is shown in FIG. 12. At the first step (600), the current “T action plan” is defined based on the “Typical T Customer profile”. Customer action data is captured upon a Customer action is going to be executed (601), the data is verified against the list of the Benefit options in the “Typical Vf(T) Profiled matrix” and “Typical Cf(T) profiled matrix”(602). If the Customer action doesn't match any of the Benefit options these matrixes are referred to; a default Benefit event is recommended (603). If there is matching, all the relevant Benefit events alternatives for this Customer action are identified (604). Then for each of the relevant Benefit events alternatives, Vf & Cf values are captured from the “Typical Vf(T) Profiled matrix” and “Typical Cf(T) profiled matrix” (605). Using these Vf & Cf values, CCV(E) indexes are calculated for all the relevant Benefit events alternatives (606). The Benefit event with the highest CCV(E) is recommended (607). The way each customer action was executed along the current T period is collected (608). On defined time intervals along the current T period, the matching to the T action plan is verified (609). If execution fits the “T action plan” no action is required (610). In a case deviation is recognized (611), an analysis is run to identify the deviation root cause (612), and the “Typical Vf(T) Profiled matrix” and “Typical Cf(T) profiled matrix” are modified in order to match “Typical T customer profile” at the rest of current T period. Adjusted “Typical Vf(T) Profiled matrix” and “Typical Cf(T) profiled matrix” will be used in real-time while following customer actions will be executed till the end of the current T period (614).

### CCV Payment Optimization System

In accordance with some embodiments of the present invention, a system called “CCV Payments optimization system” is created. “CCV Payments optimization system” aimed to execute the Personalize Benefit option optimization process as a day-to-day operation. The system has four main building blocks: Database, Customer profiling engine, Optimization engine, and Application. The system executes CCV methodologies processes, applying CCV methodology into the day-to-day commercial environment. It should be understood that certain elements may be additionally incorporated into the system and that the following figures only show certain basic system elements (illustrated in the form of functional blocks) and system operation flows.

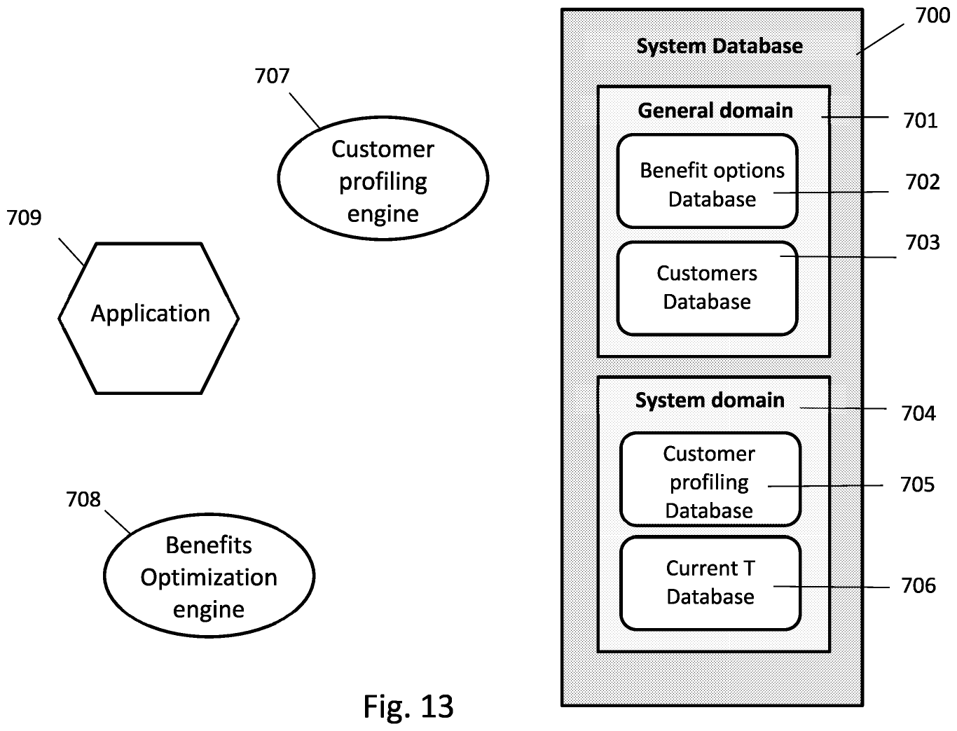

FIG. 13 shows the CCV Payments optimization system general scheme, according to an embodiment of the invention. System Database (700) contains all the relevant data needed for the system operation. The database is divided into two main domains, the General domain (701) and the System domain (704). There are two main sections in the General domain: The first section is the Benefit options database (702), which includes all Benefit options data as: Benefit value (BV), Benefit-cost (BC), grant, and/or redeem conditions, etc. The second section is, Customer database (703), which includes each individual customer data as: Available Payment tools, Loyalty programs membership, Benefit options eligibility, Customer actions history records, Customer benefits grant and redeem history, Current Customer benefits grant, and/or redeem status, etc. System domain data is generated by the system and includes two main sections. The first section is the Customer profiling database (705), which stores each individual customer: “Typical T PBE scheme”, “Current T action plan”, “Typical Vf(T) Profiled matrix”, and “Typical Cf(T) profiled matrix”. The second section is, Current T database (706), which contains each customer's Current T data; this section is updated along the current T period.

The customer profiling engine (707) executes the Profiling process. The Customer profiling engine is an advanced computing system, which uses a variety of computing analysis techniques such as advanced algorithms, AI, Deep learning to perform the profiling process. The Profiling engine pulls the required data from the database. In case some data is missing, the profiling engine makes a data request to the database, and the database can interact with the data owner to capture it. Profiling engine produces “Typical T Customer profile”, “Current T action plan”, “Typical Vf(T) Profiled matrix”, and “Typical Cf(T) profiled matrix”. Benefits Optimization engine (708) executes the Benefit optimization process. The Optimization engine runs the optimization approach process defined by the system.

The Application (709) serves as an interface of the “CCV Payments optimization system”. All system interactions with the customer are done through the application. For example, the Customer registration process is done using the application, Capturing customer personalization inputs, updating the customer with the Optimization system recommendations, etc. The application can interact through APIs with relevant Merchants, Service providers, Payment institutes, and Finance institute systems and/or applications. An application can be installed on any connected device such as desktop computers, tablets, mobile phones, etc.

### CCV Payments Optimization System Operation Flows

In accordance with some embodiments of the present invention, CCV Payments optimization system operation may include the following main activities: General domain database setup, Customer profiling process execution, Real-time optimization process execution, Payments execution, and Current T monitoring.

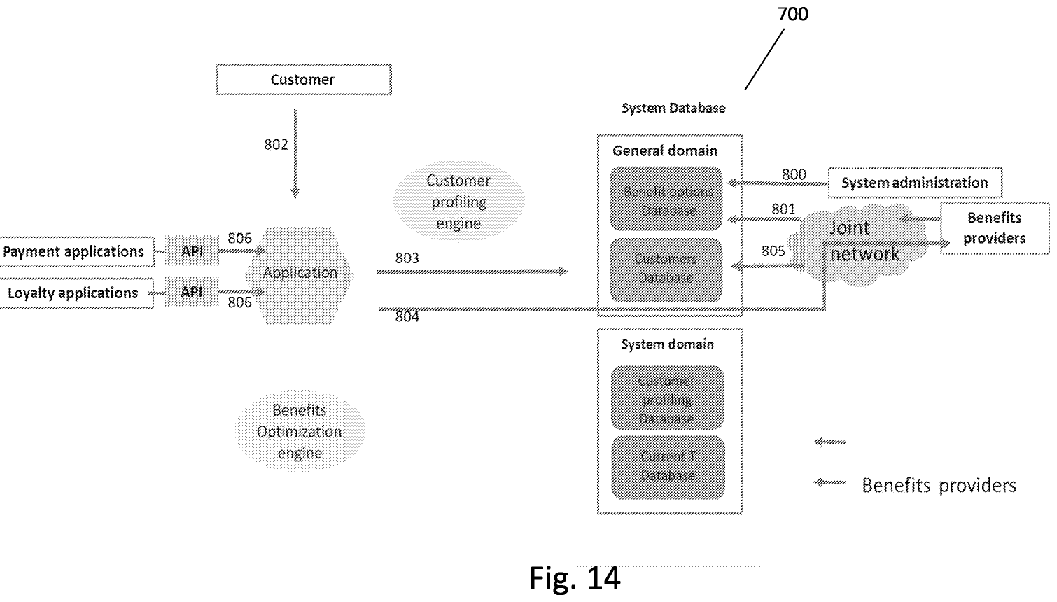

According to an embodiment of the invention, a general domain database setup establishes a Benefit options database and Customer database. According to some embodiments of the invention, Benefit option database data is captured by CCV Payment optimization system administration (800), e.g., as shown in FIG. 14. For example, by exploring Benefit options provider public data, or by using automatic data collection tools, likes: Data Mining, Web Crawling, Web Scraping, and Data Harvesting. In some embodiments, the Benefit options providers updated the Benefit options database with their Benefit options data, for example, using external update link to Benefit options database, or using joint update network and automated data transfer processes between the CCV payment Optimization system computing systems and Benefit providers computing systems (801).

According to some embodiments of the invention, the Customer database data setup is captured directly from the customer. As the customer is registered through the application to the system service and passed Identification and authentication processes, the customer data collection process is initiated through the application (802). The application transfers the data to the customer database (803). Direct customer data collection can be done, for example, by a Customer that scans his/her payment tools and loyalty membership cards, or a Customer questionnaire about average T spending level at a relevant merchant, benefit options grant and/or redeem rates, etc. In some embodiments, the registration process includes system authorization to get Customer personal data from Benefit providers. As the customer is enrolled in the system, the application notified Benefit providers that this specific customer authorizes the system to collect his personal data and initiate a data request process through the joint update network (804). As the request is received in Benefit providers' computing systems, relevant customer data is transferred automatically through the network to the Customer database (805). Missing data is completed by initiating direct customer data requests.

In some embodiments, the system application may interact with other applications on the customer computing device through APIs and gather customer data directly from application to application. For example, in case a payment or loyalty application is installed on the customer device, the system application initiates a data request to these applications through a defined API and gathers the data (806). Then the application will transfer this data to the Customer database (803).

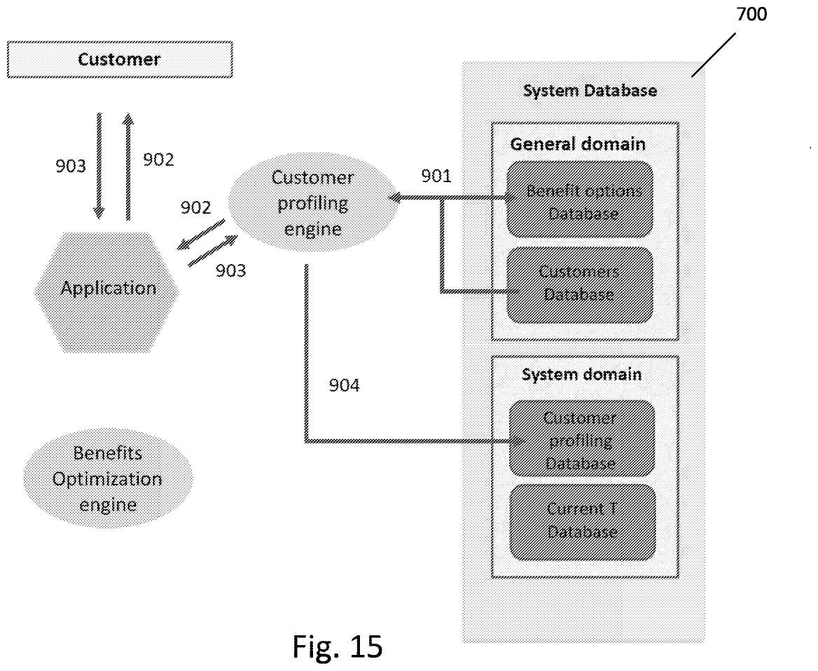

Customer profiling process is executed by the Profiling engine (e.g., as shown in FIG. 15 in accordance with an embodiment of the invention). Based on the Defined T period, the profile engine pulls relevant customer data to build (T) CAD from the Customer database and relevant Benefit options data from the Benefit option data based to build (T) BOD (901). In case a personalization stage is included in the profiling process, the profiling engine sends a data request through the application to the customer (902). Customer inputs are captured by the application and transferred to the profiling engine (903). Upon the profiling process is finished, it outputs “ Typical T Customer profile”, “Current T action plan”, “Typical Vf(T) Profiled matrix”, and “Typical Cf(T) profiled matrix” are stored in the Customer profiling database (904).

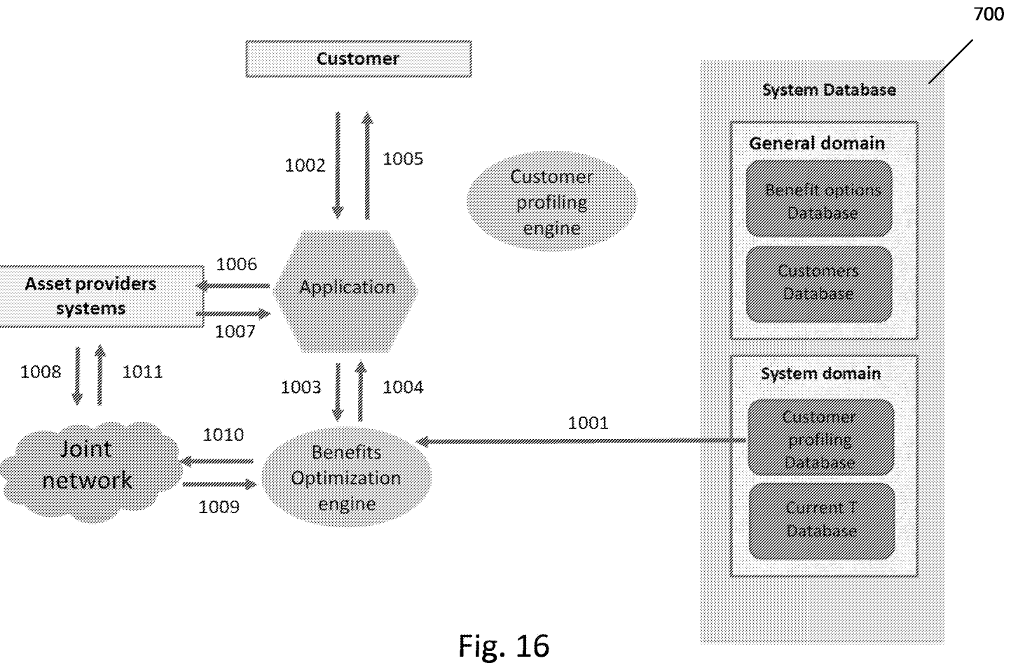

Real-time optimization process execution aim is to define and inform a recommendation on how to execute each Customer action. This process is executed by the Optimization engine (e.g., as shown in FIG. 16 in accordance with an embodiment of the invention). At the beginning of each “current T” period, the Optimization engine pulled, based on the defined optimization approach (Factors, Profile or Combined), “Typical Vf(T) Profiled matrix” and “Typical Cf(T) profiled matrix” and\or “T Customer profile” from the “Customer profiling database” (1001).

In some embodiments (e.g., as shown in FIG. 16 in accordance with an embodiment of the invention), customer action information is transferred to the Optimization engine by the customer through the application (1002,1003). The optimization engine runs the defined optimization process and updates customers with Benefit event recommendations through the application (1004, 1005).

In some embodiments, connection (as shown in FIG. 16) is established between the Asset providers (a merchant, service provider) systems and the application. As customer action is about to execute, the application connects to the asset provider system with data request (1006), then customer action information is transferred to the application directly from this system (1007). For example, Cash Register updates purchase details to the application, Web or Mobile applications updates service payment details to the application, etc. Application transferred customer action information to the Optimization engine (1003), which runs the defined optimization process and updates the customer with Benefit event recommendations through the application (1004, 1005).

In some embodiments (as shown in FIG. 16), the connection is established between the Asset providers (a merchant, service provider) systems and the Optimization engine through a joint network. As customer action is about to execute, the application connects to the asset provider system with Customer identification and\or data request (1006), then customer action information is transferred from the Asset provider system through the joint network (1008) to the Optimization engine (1009). Optimization engine (runs the defined optimization process and updates the customer with Benefit event recommendations through the application (1004,1005) or through the joint network and the Asset provider system (1010, 1011, 1007).

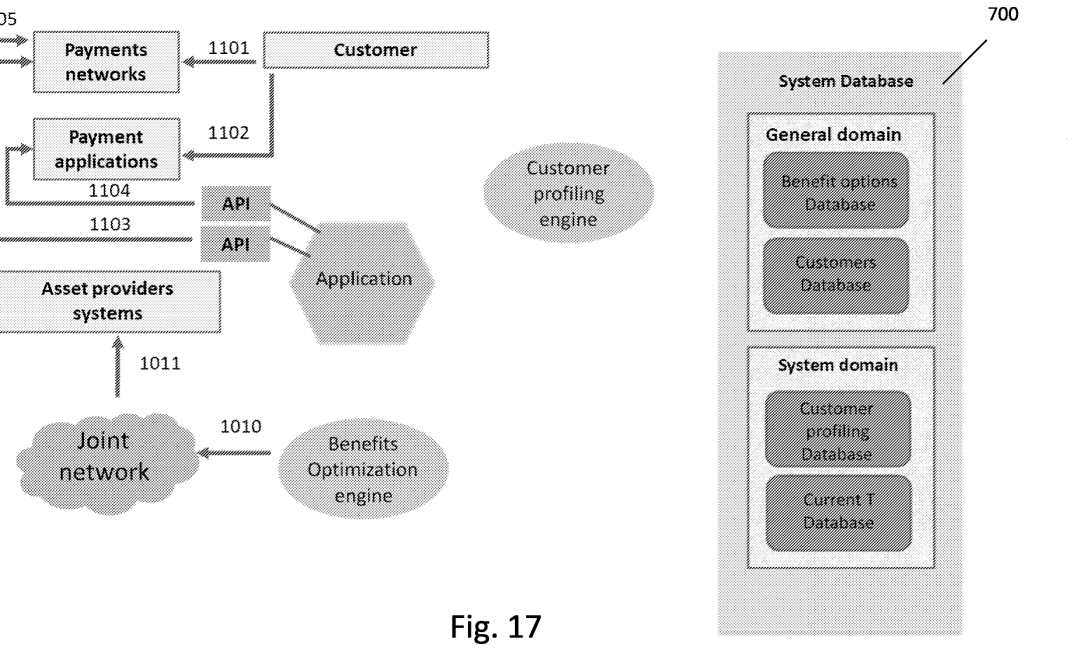

Payment process execution is done based on Optimization engine recommendation (e.g., as shown in FIG. 17 in accordance with an embodiment of the invention). In some embodiments, the customer is executing the payment based on the recommendation which was delivered to him by the application, in any Payment networks (1101) or Payment application (1102) is available for him.

In some embodiments (as shown in FIG. 17), the connection is established between the Application and Payment networks or Payment application. The customer authorized the application to execute the recommended Benefit event payment automatically. As the application gets an Optimization engine recommendation, relevant payment is executed through APIs, which are established between the application and Payment networks (1103) or Payment application (1104).

In some embodiments (as shown in FIG. 17), the connection is established between the Asset providers' systems and the payment network. The customer authorized the Asset providers' systems to execute the recommended Benefit event payment automatically as the Asset providers system gets Optimization engine recommendations through their joint network (1010, 1011). Relevant payment is executed through the asset provider system connections with the Payment networks (1105).

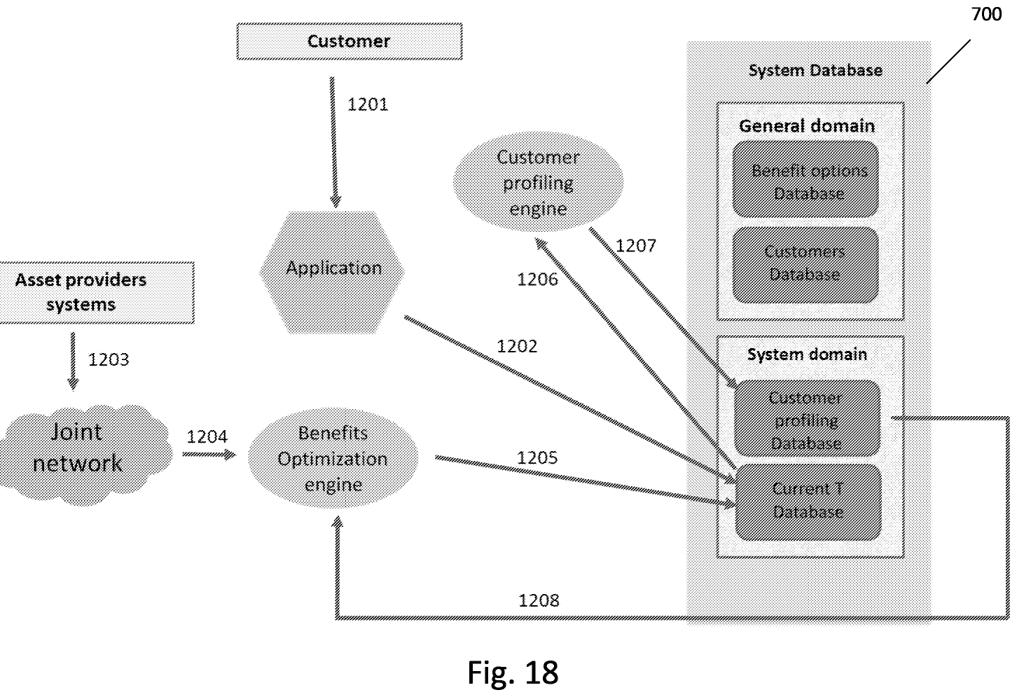

Current T monitoring process's aim is to track current T payments executing in order to verify that Benefit optimization goals are achieved (e.g., as shown in FIG. 18 in accordance with an embodiment of the invention). Current T Customer actions details are transferred to the “Current T database” as a customer action is executed. This update is done by the customer through the application (1201,1202), by the application (1202), or by the Asset provider through the joint network and the Optimization engine (1203, 1204, 1205).

According to an embodiment of the invention, on a defined time interval by the system administration, the Profiling engine pulls Current T data from the “Current T database” (1206) and runs the “T Action plan” matching verification process.

According to an embodiment of the invention, in case a deviation from the “T action plan” is detected, The profiling engine makes needed adjustments to the “T action plan” and\or “Typical Vf(T) Profiled matrix” and “Typical Cf(T) profiled matrix”. Adjust “T action plan” and\or “Typical Vf(T) Profiled matrix” and “Typical Cf(T) profiled matrix” is transferred to the Customer profiling database (1207). Customer profiling database notifying Optimization engine that changes were done, Optimization engine pulling the adjusted “Typical Vf(T) Profiled matrix” and “Typical Cf(T) profiled matrix” and\or “Taction plan” (1208). Optimization engine use for rest of T the modified adjusted “Typical Vf(T) Profiled matrix” and “Typical Cf(T) profiled matrix” and\or “T action plan”.

A number of embodiments of the disclosure have been described. Nevertheless, it will be understood that various modifications may be made without departing from the spirit and scope of the present disclosure. Accordingly, other embodiments are within the scope of the following claims.

1-44. (canceled)

45. A method for calculating a personalized value for a benefit option in a real-time payment system, comprising:
receiving data from a benefit options database and a customer database;
calculating a Calculated Customer Value (CCV) index using said data; and
applying weight factors to said CCV index to consider a customer's personal risk profile and preferences.

46. The method of claim 45, wherein said CCV index is calculated using at least the following parameters: Benefit option Value (BV), Benefit option Cost (BC), Benefit option Redeem probability (BR), and Benefit option Grant probability (BG).

47. The method of claim 46, wherein calculating the CCV index for a benefit option using the received data comprising:
defining the CCV index as a function of Benefit Option Value (BV), Benefit Option Cost (BC), Benefit Option Redeem Probability (BR), and Benefit Option Grant Probability (BG), wherein the CCV index is represented as CCV(B)=f(BV, BC, BR, BG);
incorporating Weight Factors (Vw, Cw, Rw, Gw) into the CCV index in accordance with customer-specific information, wherein the weighted CCV index is represented as Weighted CCV(B)=f(BV*Vw, BC*Cw, BR*Rw, BG*Gw);
simplifying the weighted CCV equation by introducing at least a Benefit Option Value Factor (Vf) and a Benefit Option Cost Factor (Cf) to minimize computational complexity; and
applying weight factors to the calculated CCV index, said weight factors being dynamically determined in real-time or pre-defined based on the customer's historical data and general risk aversion, to yield a personalized CCV index that accounts for the customer's personal risk profile and preferences.

48. The method of claim 45, further comprising calculating a group CCV index for multiple benefit options.

49. The method of claim 45, further comprising classifying connections between customer actions and benefit options by defining a Customer Action Domain (CAD) and a Benefit Options Domain (BOD).

50. The method of claim 49, further comprising defining alternative benefit events which can coexist for a defined CAD.

51. The method of claim 50, further comprising defining Benefit event CCV index (CCV(E)).

52. The method of claim 45, further comprising using personalized conditions to adjust the weight factors.

53. The method of claim 45, wherein said method is executed in real-time, and further comprising recommending a benefit option with the highest CCV index value.

54. The method of claim 45, wherein the classification of Benefit events is based on CAD and BOD characteristics.

55. The method of claim 45, further comprising identifying Time Events and calculating CCV for such Time Events.

56. A system for real-time personalized payment and benefit optimization, comprising:
a benefit options database configured to receive data from a system administration or from benefit providers;
a customer database configured to receive data from customers through a digital application, or from other connected systems;
a customer profiling engine configured to execute a Calculated Customer Value (CCV) profiling process using data from the benefit options database and customer database;
a real-time benefit optimization engine configured to recommend a benefit option with the highest CCV index value in real-time.

57. The system of claim 56, wherein said real-time benefit optimization engine receives customer action data for benefit optimization.

58. The system of claim 56, wherein said benefit optimization engine communicates the recommended benefit option directly to the customer.

59. The system of claim 56, wherein the system is adapted to execute recommended benefit options automatically upon customer authorization.

60. The system of claim 56, wherein the customer profiling engine uses the customer's personal conditions to adjust the weight factors in the CCV index.

61. The system of claim 56, further comprising a digital application that serves as an interface to asset and financial providers.
